(19) United States
(12) Patent Application Publication
(10) Pub. No.: US 2025/0333080 A1
(43) Pub. Date: Oct. 30, 2025

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 19/264,164

(22) Filed: Jul. 9, 2025

Related U.S. Application Data
(63) Continuation of application No. PCT/JP2023/046952, filed on Dec. 27, 2023.

(30) Foreign Application Priority Data
Jan. 25, 2023 (JP) 2023-009666
Dec. 21, 2023 (JP) 2023-215998

(51) Int. Cl. B60W 60/00; B60W 10/18; B60W 30/14; B60W 30/18; B60W 40/08; B60W 50/00; B60W 50/02; B60W 50/14

(52) U.S. Cl. CPC B60W 60/0025; B60W 10/18; B60W 30/146; B60W 30/18154; B60W 30/18163; B60W 40/08; B60W 50/0205; B60W 50/14; B60W 60/0023; B60W 2040/0881; B60W 2050/0083; B60W 2050/146; B60W 2552/05; B60W 2554/802; B60W 2555/60

(57) ABSTRACT

A vehicle control method can be used in a service vehicle that transports a transport target as a service using autonomous driving. It is specified whether at least one of an occupant and a baggage is disposed as a transport target in the service vehicle. A driving allowance degree, which is a range of a driving control of the service vehicle allowed in the autonomous driving, is changed according to a specified result.

### CROSS REFERENCE TO RELATED APPLICATION

The present application is a continuation application of International Patent Application No. PCT/JP2023/046952 filed on Dec. 27, 2023, which designated the U.S. and claims the benefit of priority from Japanese Patent Applications No. 2023-009666 filed on Jan. 25, 2023, and No. 2023-215998 filed on Dec. 21, 2023. The entire disclosures of all of the above applications are incorporated herein by reference.

### TECHNICAL FIELD

The present disclosure relates to a vehicle control device and a vehicle control method.

### BACKGROUND

A conceivable technique teaches an autonomous driving control unit that includes autonomous driving functions from level 1 to level 5 in addition to the manual driving function at level 0. As an autonomous driving vehicle, a service vehicle that transports a target such as an occupant or a baggage as a service is being considered.

### SUMMARY

According to an example, a vehicle control method can be used in a service vehicle that transports a transport target as a service using autonomous driving. It is specified whether at least one of an occupant and a baggage is disposed as a transport target in the service vehicle. A driving allowance degree, which is a range of a driving control of the service vehicle allowed in the autonomous driving, is changed according to a specified result.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an example of a schematic configuration of a vehicle system according to a first embodiment;

FIG. 2 is a diagram showing an example of a schematic configuration of an autonomous driving ECU according to the first embodiment;

FIG. 3 is a diagram for explaining an example of a feature of a driving allowance degree, a vehicle compartment notification, and a vehicle outside notification according to the presence or absence of an occupant;

FIG. 4 is a diagram showing an example of a schematic configuration of a vehicle system according to a second embodiment;

FIG. 5 is a diagram showing an example of a schematic configuration of an autonomous driving ECU according to the second embodiment;

FIG. 6 is a diagram for explaining an example of a feature of a driving allowance degree and a vehicle outside notification according to the presence or absence of a baggage;

FIG. 7 is a diagram showing an example of a schematic configuration of a vehicle system according to a third embodiment;

FIG. 8 is a diagram showing an example of a schematic configuration of an autonomous driving ECU according to the third embodiment;

FIG. 9 is a diagram showing an example of a schematic configuration of a vehicle system according to a fourth embodiment;

FIG. 10 is a diagram showing an example of a schematic configuration of an autonomous driving ECU according to the fourth embodiment;

FIG. 11 is a diagram for explaining an example of a feature of a driving allowance degree and a vehicle outside notification according to the presence or absence of each of an occupant and a baggage;

FIG. 12 is a diagram showing an example of a schematic configuration of a vehicle system according to a fifth embodiment;

FIG. 13 is a diagram showing an example of a schematic configuration of an autonomous driving ECU according to the fifth embodiment;

FIG. 14 is a diagram showing an example of a schematic configuration of a vehicle system according to a sixth embodiment;

FIG. 15 is a diagram showing an example of a schematic configuration of an autonomous driving ECU according to the sixth embodiment;

FIG. 16 is a diagram showing an example of a schematic configuration of a vehicle system according to a seventh embodiment;

FIG. 17 is a diagram showing an example of a schematic configuration of an autonomous driving ECU according to the seventh embodiment;

FIG. 18 is a diagram showing an example of a schematic configuration of a vehicle system according to an eighth embodiment;

FIG. 19 is a diagram showing an example of a schematic configuration of an autonomous driving ECU according to the eighth embodiment;

FIG. 20 is a diagram showing an example of a schematic configuration of a vehicle system according to an ninth embodiment; and

FIG. 21 is a diagram showing an example of a schematic configuration of an autonomous driving ECU according to the ninth embodiment.

### DETAILED DESCRIPTION

In order to provide high-quality service, it is considered that autonomous driving control is required for service vehicles to prevent anomaly from occurring in the transport target. However, the service vehicle does not always carry an transport target. Therefore, if the same autonomous driving control is executed regardless of whether or not a transport target is carried, there may be a risk that unnecessary control will increase.

One object of the present embodiments is to provide a vehicle control device and a vehicle control method that can provide high-quality service while reducing unnecessary control in a service vehicle that transports a target as a service using autonomous driving.

The above object is achieved by the combination of features described in the embodiments, and the combination of features define further advantageous specific examples of the embodiments. Here, a reference numeral in parentheses indicate a correspondence relationship with specific means described in embodiments to be described later as one aspect, and does not limit the technical scope of the present embodiments.

In order to achieve the above-described features, a vehicle control device according to the present embodiments is a vehicle control device that can be used in a service vehicle that transports a target as a service using autonomous driving.

The vehicle control device includes: a transport target specifying unit that specifies whether at least one of an occupant and a baggage is disposed as a transport target in the service vehicle; and an allowance degree change unit that changes a driving allowance degree, which is a range of a driving control of the service vehicle allowed in the autonomous driving, according to a specified result by the transport target specifying unit.

In order to achieve the above-described features, a vehicle control method according to the present embodiments is a vehicle control method that can be used in a service vehicle that transports a target as a service using autonomous driving.

The vehicle control method, executed by at least one processor, includes: a transport target specifying step that specifies whether at least one of an occupant and a baggage is disposed as a transport target in the service vehicle; and an allowance degree change step that changes a driving allowance degree, which is a range of a driving control of the service vehicle allowed in the autonomous driving, according to a specified result in the transport target specifying step.

According to the above configuration, it is possible to change the range of the driving control of the service vehicle that is allowable in the autonomous driving according to whether there is a transport target in the service vehicle. Therefore, it is possible to allow the driving control in a range that is appropriate for the presence or absence of a transport target, according to the presence or absence of a transport target. As a result, it is possible to provide high-quality service while reducing unnecessary control in a service vehicle that transports a target as a service using the autonomous driving.

The following will describe multiple embodiments of the present disclosure with reference to the drawings. For convenience of explanation, the same reference numerals are assigned to portions having the same functions as those illustrated in the drawings used in the description so far among the plurality of embodiments, and the description of the portions may be omitted. For the elements denoted by the same reference symbols, the description thereof may be referred to in other embodiments.

### First Embodiment

### <Schematic Configuration of Vehicle System 1>

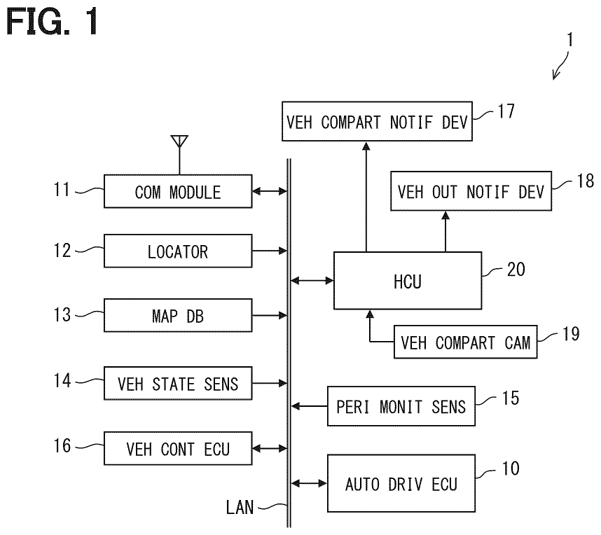

The following will describe a first embodiment of the present disclosure with reference to the accompanying drawings. A vehicle system 1 shown in FIG. 1 can be used for a vehicle that transports a target as a service using autonomous driving (hereinafter referred to as a service vehicle). Examples of the service vehicle include a passenger transport vehicle for transporting an occupant as a transport target, and a baggage transport vehicle for transporting a baggage as a transport target. The passenger transport vehicle includes a taxi, a bus, and the like. The baggage transport vehicle includes a truck, a delivery vehicle, a postal vehicle, and the like. In the following, an example will be described in which the service vehicle is a passenger transport vehicle.

As shown in FIG. 1, the vehicle system 1 includes an autonomous driving ECU 10, a communication module 11, a locator 12, a map database (hereinafter referred to as map DB) 13, a vehicle state sensor 14, a periphery monitoring sensor 15, a vehicle control ECU 16, a vehicle compartment notification device 17, a vehicle outside notification device 18, a vehicle compartment camera 19, and a HCU (Human Machine Interface Control Unit) 20. For example, the autonomous driving ECU 10, the communication module 11, the locator 12, the map DB 13, the vehicle state sensor 14, the periphery monitoring sensor 15, the vehicle control ECU 16, and the HCU 20 may be configured to be connected to an in-vehicle LAN (see LAN in FIG. 1). Although the vehicle using the vehicle system 1 is not necessarily limited to an automobile, hereinafter, an example using the automobile will be described.

There may be a plurality of stages (hereinafter, referred to as automation levels) of autonomous driving of an autonomous driving vehicle, for example, as defined by SAE (the Society of Automotive Engineers). This automation level is classified into, for example, five levels including LV 0 to LV 5 as follows.

LV 0 is a level at which a driver performs all driving tasks without intervention of the system. The driving tasks may be rephrased as dynamic driving tasks. The driving tasks are, for example, a steering operation, an acceleration and deceleration operation, and a periphery monitoring operation. The LV 0 corresponds to so-called manual driving. The LV 1 is a level at which the system supports either the steering operation or the acceleration and deceleration operation. The LV 1 corresponds to so-called driving assistance. The LV 2 is a level at which the system supports both the steering operation and the acceleration and deceleration operation. The LV 2 corresponds to so-called partial driving automation. The LV1 and LV2 are also part of autonomous driving.

For example, the autonomous driving at LV 1 and LV 2 is autonomous driving in which a driver has an obligation of monitoring related to safety driving operation (hereinafter simply referred to as a monitoring obligation). That is, this corresponds to autonomous driving with the monitoring obligation. Here, the driving operations at LV0 to LV2 correspond to the driving operations requiring monitoring. The monitoring obligation includes visual monitoring of a periphery of the vehicle. The autonomous driving at LV1 and 2 can be rephrased as autonomous driving in which a second task is not permitted. The second task is an action other than driving permitted for the driver, and is a specific action defined in advance. The second task can also be reworded as a secondary activity, other activities, or the like. The second task must not prevent the driver from responding to a request to take over a driving operation from an autonomous driving system. As an example, viewing of a content such as a video, operation of a smartphone, reading a book, and eating may be assumed as the second task.

The LV 3 of the autonomous driving is a level where the system performs all driving tasks under certain conditions, and the driver performs the driving operation in an emergency situation. In the LV 3 of the autonomous driving, the driver must be able to respond quickly when the system requests to take over the driving operation. The driving takeover can also be rephrased as transfer of the periphery monitoring obligation from the vehicle system to the driver. The LV 3 corresponds to so-called conditional driving automation. The autonomous driving at the LV4 is at a level at which the system can perform all the driving tasks except for a specific situation such as an unsupported road, an extreme environment, and the like. The LV 4 corresponds to so-called advanced driving automation. The LV 5 of the autonomous driving is a level at which the system can perform all the driving tasks under all environments. The LV 5 corresponds to a full driving automation. The autonomous driving of LV4 and LV5 may be implemented, for example, in a traveling section where high-precision map data is prepared. The high-precision map data will be described later.

For example, the autonomous driving at LV 3 or higher is an autonomous driving in which the driver does not have the monitoring obligation. In other words, the autonomous driving at LV 3 to LV 5 corresponds to autonomous driving with no monitoring obligation. The autonomous driving at LV 3 or higher can be rephrased as autonomous driving in which the second task is permitted. For example, the autonomous driving at level 4 or higher is the autonomous driving that allows the driver to sleep. In other words, the autonomous driving at LV 4 or higher corresponds to autonomous driving with sleep permission. The autonomous driving of LV4 or higher corresponds to the autonomous driving capable of unmanned driving. In this embodiment, an example will be described in which a passenger transport vehicle executes the autonomous driving of LV4 or higher. In addition, in a case where a passenger transport vehicle is a vehicle that always requires a driver to monitor the operation (hereinafter referred to as the monitoring driver) to be on the vehicle, the passenger transport vehicle may be configured to execute the autonomous driving of LV3 or higher.

The communication module 11 transmits and receives information to and from a center outside the vehicle via wireless communications. That is, the communication module 11 executes a wide area communication. The communication module 11 receives traffic congestion information and the like from the center through the wide area communication. The communication module 11 may transmit and receive information to and from other vehicles via the wireless communication. In other words, the communication module 11 may execute a vehicle-to-vehicle communication. The communication module 11 may transmit and receive information via the wireless communication with a roadside device arranged on a roadside. That is, road-to-vehicle communication may be executed. When performing the road-to-vehicle communication, the communication module 11 may receive peripheral vehicle information transmitted from the vehicle positioned in the periphery of the vehicle via the roadside device. Further, the communication module 11 may receive information about a peripheral vehicle transmitted from the vehicle positioned in the periphery of the subject vehicle via the center by the wide area communication.

The locator 12 includes a GNSS (i.e., Global Navigation Satellite System) receiver and an inertial sensor. The GNSS receiver receives positioning signals from a plurality of positioning satellites. The inertial sensor includes, for example, a gyro sensor and an acceleration sensor. The locator 12 combines the positioning signals received by the GNSS receiver with a measurement result of the inertial sensor to sequentially detect the position of the subject vehicle (hereinafter, a subject vehicle position). The subject vehicle position may include, for example, coordinates of latitude and longitude. The subject vehicle position may be measured by using a travel distance acquired from signals sequentially output from a vehicle speed sensor mounted on the vehicle.

The map DB 13 is a non-volatile memory and stores the high-precision map data. The high accuracy map data is map data with higher accuracy than map data used for route guidance by a navigation function. The high-precision map data includes information that can be used for the autonomous driving operation, such as, for example, three-dimensional road shape information, information on the number of lanes, and information indicating the traveling direction allowed for each lane. The high accuracy map data may include information on node points indicating positions of both ends of a road marking such as a lane marking. The map DB 13 may also store map data used for route guidance. The locator 12 may be configured not to use the GNSS receiver by using the three-dimensional shape information on a road. For example, the locator 12 may be configured to specify the vehicle position using three-dimensional shape information of the road and the detection results of the periphery monitoring sensor 15. The three-dimensional shape information of the road may be generated based on a captured image by the REM (i.e., Road Experience Management).

The map data distributed from an external server may be received, for example, through the wide area communications by a communication module 11 and stored in the map DB 13. In this case, the map DB 13 may be a volatile memory, and the communication module 11 may sequentially acquire the map data of an area corresponding to the subject vehicle position.

The vehicle state sensor 14 is a sensor group for detecting various states of the subject vehicle. Examples of the vehicle state sensor 14 may be a vehicle speed sensor, a seating sensor, and the like. The vehicle speed sensor detects the speed of the subject vehicle. The seating sensor is a sensor for detecting whether an occupant is seated in a seat of the vehicle. As an example, a pressure-sensitive element may be used as the seating sensor. The vehicle state sensor 14 outputs detected sensing information to the in-vehicle LAN. Here, the sensing information detected by the vehicle state sensor 14 may be output to the in-vehicle LAN via an ECU mounted on the subject vehicle.

The periphery monitoring sensor 15 monitors a peripheral environment of the subject vehicle. For example, the periphery monitoring sensor 15 detects an obstacle in a periphery of the subject vehicle, such as a pedestrian, a mobile object like an other vehicle, and a stationary object such as a fallen object on the road. The road marking such as a traveling lane marking surrounding the subject vehicle is detected. The periphery monitoring sensor 15 is, for example, a periphery monitoring camera that captures an image of a predetermined range around the vehicle, or a probe wave sensor that transmits search waves to a predetermined range around the vehicle. For example, the probe wave sensor may be provided by a sonar, Light Detection and Ranging/Laser Imaging Detection and Ranging (i.e., LIDAR), a millimeter wave radar, or the like. For example, the predetermined range may be a range at least partially including the front area, the rear area, the left area, or the right area of the subject vehicle. The periphery monitoring camera sequentially outputs, as sensing information, sequentially captured images to the autonomous driving ECU 10. The probe wave sensor sequentially outputs the scanning results based on the received signal acquired when receiving a reflection wave reflected by an obstacle to the autonomous driving ECU 10 as sensing information.

The vehicle control ECU 16 is an electronic control unit configured to perform a traveling control of the subject vehicle. Examples of the travel control include acceleration and deceleration control and/or steering control. Examples of the vehicle control ECU 16 include a steering ECU that performs steering control, a power unit control ECU that performs the acceleration and deceleration control, and a brake ECU. The vehicle control ECU 16 executes the driving control by outputting control signals to each driving control device mounted on the vehicle. Examples of the driving control devices include an electronic control throttle, a brake actuator, and an EPS (i.e., Electric Power Steering) motor.

The vehicle compartment notification device 17 is provided in the vehicle and issues a notification to the vehicle compartment of the vehicle. That is, the vehicle compartment notification device 17 issues a notification to the occupant of the vehicle. The vehicle compartment notification device 17 executes notification according to an instruction from the HCU 20. The vehicle compartment notification device 17 includes at least one of an vehicle compartment display device and an vehicle compartment sound output device.

The vehicle compartment display device provides the notification by displaying information. The vehicle compartment display device may be, for example, a meter MID (i.e., Multi Information Display), a CID (i.e., Center Information Display), or a HUD (i.e., Head-Up Display). The meter MID is a display device located in front of the driver seat in the vehicle compartment. As an example, the meter MID may be arranged on the meter panel. The CID is a display device disposed at a center of an instrument panel of the subject vehicle. The HUD is provided in, for example, the instrument panel in the vehicle compartment. The HUD projects a display image formed by an projector onto a predetermined projection area on a front windshield as a projection member. The HUD may be configured to project the display image onto a combiner instead of the front windshield. The vehicle compartment sound output device executes the notification by outputting sound. As the vehicle compartment sound output device, a speaker or the like provided in the vehicle compartment of the subject vehicle can be used.

The vehicle outside notification device 18 issues an notification to the outside of the vehicle. The vehicle outside notification device 18 includes at least one of a vehicle outside display device and a vehicle outside sound output device. The vehicle outside display device is installed on the vehicle outside of the subject vehicle and executes the display toward the outside of the subject vehicle. The vehicle outside display 191 may execute the display by light emission of a lamp, and the emission may not include the display of text and images, for example. The vehicle outside display 191 may be a display that shows a text, an image, and the like. The vehicle outside sound output device executes the notification by outputting sound. As the vehicle outside sound output device, a speaker or the like provided on the vehicle exterior of the subject vehicle can be used.

The vehicle compartment camera 19 is an imaging device that captures an image of a predetermined range within the compartment of the vehicle. The vehicle compartment camera 19 includes, for example, a near-infrared light source, a near-infrared camera unit, and a control unit that controls these components. The vehicle compartment camera 19 uses the near-infrared camera to capture an image of the occupant of the subject vehicle to which the near-infrared light is emitted from the near-infrared light source.

The HCU 20 mainly includes a computer including a processor, a volatile memory, a nonvolatile memory, an I/O, and a bus connecting these devices. The HCU 20 executes various processing related to an interaction between an occupant and a system of the subject vehicle by executing a control program stored in the nonvolatile memory. The HCU 20 acquires the images captured by the vehicle compartment camera 19. The HCU 20 specifies the number of the occupant of the vehicle from the images captured by the vehicle compartment camera 19. The HCU 20 controls the vehicle compartment notification device 17 and the vehicle outside notification device 18 to issue the notification.

The autonomous driving ECU 10 mainly includes a computer including a processor, a volatile memory, a nonvolatile memory, an I/O, and a bus connecting these devices. The autonomous driving ECU 10 executes processing related to the autonomous driving by executing a control program stored in the nonvolatile memory. The autonomous driving ECU 10 corresponds to a vehicle control device. The configuration of the autonomous driving ECU 10 will be described in detail below.

### <Schematic Configuration of Autonomous Driving ECU 10>

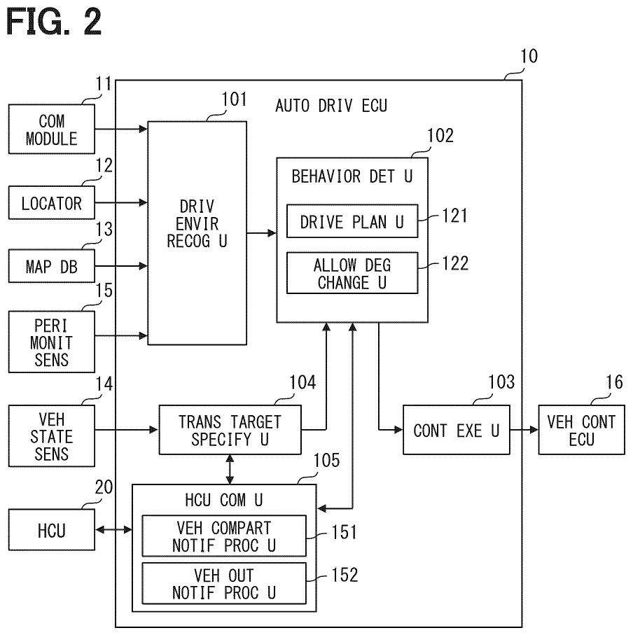

Next, a schematic configuration of the autonomous driving ECU 10 will be described with reference to FIG. 2. As shown in FIG. 2, the autonomous driving ECU 10 includes a driving environment recognition unit 101, a behavior determination unit 102, a control execution unit 103, a transport target specifying unit 104, and a HCU communication unit 105 as functional blocks. The execution of the processes of the functional blocks of the autonomous driving ECU 10 by the computer corresponds to execution of a vehicle control method. Some or all of the functions executed by the autonomous driving ECU 10 may be implemented as hardware with one or more ICs or the like. Some or all of the functional blocks included in the autonomous driving ECU 10 may be implemented by a combination of execution of software by a processor and a hardware element.

The driving environment recognition unit 101 recognizes the driving environment of the vehicle from the vehicle position, map data, and sensing information acquired from the periphery monitoring sensor 15. The vehicle position may be acquired from the locator 12. The map data may be acquired from the map DB 13. As one example, with use of these information, the driving environment recognition unit 101 recognizes a position, a shape and a movement state of an object in the periphery of the subject vehicle, and generates a virtual space in which the actual traveling environment is reproduced. The driving environment recognition unit 101 may recognize, from the sensing information, the presence, relative position, and relative speed of periphery vehicles with respect to the subject vehicle as the driving environment. The driving environment recognition unit 101 may recognize the position of the subject vehicle on the map from the subject vehicle position and the map data. In a case where position information, speed information, and the like of the periphery vehicle can be acquired via the communication module 11, the driving environment recognition unit 101 may recognize the traveling environment using these items of information.

The behavior determination unit 102 switches the control subject of driving operation between the driver and the vehicle system of the subject vehicle. The behavior determination unit 102 determines a traveling plan to travel the subject vehicle based on the recognition result of the travel environment by the travel environment recognition unit 101 when the system has a right to control the driving operation. The behavior determination unit 102 includes a drive plan unit 121 and an allowance degree change unit 122 as sub-functional blocks.

The drive plan unit 121 determines a drive plan for driving the vehicle in the autonomous driving mode. The drive plan unit 121 determines long-term and mid-term driving plans and short-term driving plans as the drive plans. In the long and medium term driving plan, a planned route for causing the subject vehicle to head toward a set destination is generated. The drive plan unit 121 may determine this planned route in a manner similar to the route search of the navigation function. The drive plan unit 121 may also determine the set vehicle speed when driving the planned route. The set vehicle speed may be determined according to the speed limit of each drive section. The drive plan unit 121 uses the virtual space in the periphery of the subject vehicle generated by the driving environment recognition unit 101 to determine a short-term drive plan for realizing the driving operation according to the long-term and middle-term drive plan. Specifically, the short-term drive plan determines the execution of steering for lane changes, acceleration/deceleration for speed adjustment, and steering and braking for obstacle avoidance. The processing in the allowance degree change unit 122 will be described later.

The control execution unit 103 executes the driving control in cooperation with the vehicle control ECU 16 when the control right of driving operation is held by the system of the vehicle itself. The control execution unit 103 executes the driving control such as acceleration/deceleration control and steering control of the subject vehicle in accordance with the driving plan determined by the behavior determination unit 102.

The transport target specifying unit 104 specifies whether or not a transport target is disposed in the service vehicle. The processing in the transport target specifying unit 104 corresponds to a transport target specifying step. In this embodiment, it is determined whether or not an occupant is disposed in the passenger transport vehicle. The transport target specifying unit 104 can specify whether or not there are any occupants in the passenger transport vehicle based on the number of occupants of the vehicle specified by the HCU 20 from the image captured by the vehicle compartment camera 19. If the number of passengers of the vehicle is zero, the transport target specifying unit 104 may specify that no passengers are disposed. The transport target specifying unit 104 may specify whether or not an occupant is disposed in the passenger transport vehicle based on the sensing result of the seating sensor. In this case, the seating sensors may be provided on all the seats of the vehicle.

It may be preferable that the transport target specifying unit 104 distinguishes and specifies between the presence or absence of each of a monitoring driver and a passenger as a passenger of the passenger transport vehicle. The monitoring driver and the passenger can be distinguished from each other based on their riding positions. For example, the monitoring driver may be disposed in the driver's seat of the vehicle. Alternatively, the monitoring driver may be distinguished from the passenger based on whether or not an item specific to the monitoring driver is extracted by image recognition in the HCU 20.

The transport target specifying unit 104 may be capable of specifying whether or not a transport target is disposed in the service vehicle in response to a selection input indicating whether or not a transport target is disposed in the service vehicle. This selection input may be received via a user input device that receives input from the user. The user input device may be an operation device that receives an operation input from the user. The operation device may be a mechanical switch, or may be a touch switch integrated with the display. The user input device is not limited to the operation device that receives the operation input as long as the user input device receives the input from the user. For example, the user input device 18 may be a sound input device that receives a command input by a sound such as a voice from the user. The user input device may be provided in the service vehicle, or may be provided outside the service vehicle. For example, the user input device may be a user input device included in a mobile terminal. When a user input device is provided in the service vehicle, the transport target specifying unit 104 may acquire the input from the user input device connected to the HCU 20 via the HCU communication unit 105. In the case where the user input device is provided in a mobile terminal, the transport target specifying unit 104 may acquire the input from the user input device via a wireless communication unit provided in the service vehicle.

The allowance degree change unit 122 changes the range of the driving control of the service vehicle that is allowable during the autonomous driving (hereinafter, driving allowance degree). The processing in the allowance degree change unit 122 corresponds to an allowance degree change step. For example, the driving allowance degree may be a range of behavior of the subject vehicle that is allowable during the autonomous driving. The wider the driving allowance degree is, the greater the acceleration (hereinafter, G) caused by the behavior of the subject vehicle is allowable. As an example, the driving allowance degree may include an allowable range of acceleration/deceleration, an allowable range of speed, and an allowable range of yaw rate. Other examples may include allowable behavior, allowable deceleration start timing, allowable emergency braking operation conditions, and the like. The behavior determination unit 102 determines a short-term drive plan so as to fall within the range of the driving allowance degree set by the allowance degree change unit 122. That is, the control execution unit 103 controls the driving operation of the subject vehicle so that the driving allowance degree set by the allowance degree change unit 122 is not exceeded.

The allowance degree change unit 122 changes the driving allowance degree depending on the specified result in the transport target specifying unit 104. In other words, the driving allowance degree is changed depending on whether or not an occupant is disposed. This makes it possible to change the range of the driving control of the passenger transport vehicle that is allowable during the autonomous driving depending on whether or not an occupant is disposed in the passenger transport vehicle as the transport target. Therefore, it is possible to allow the driving control within a range appropriate to the presence or absence of an occupant, depending on whether or not there is a passenger in the vehicle. As a result, in passenger transport vehicles that use the autonomous driving to transport an occupant as a service, it is possible to provide a high-quality service while reducing unnecessary control.

When the transport target specifying unit 104 specifies that no occupant is disposed in the vehicle, it may be preferable that the allowance degree change unit 122 widens the driving allowance degree compared to when the transport target specifying unit 104 specifies that an occupant is disposed in the vehicle. Examples of widening the driving allowance degree include allowance to travel at a higher speed, allowance to travel at a larger yaw rate, allowance to travel with larger acceleration/deceleration, and the like. Other examples may include starting deceleration at a later timing, increasing the number of allowable behaviors, and relaxing the conditions for emergency braking. According to the above configuration, in a situation where the burden on the occupant caused by the driving control of the subject vehicle does not need to be taken into consideration, the driving control that prioritizes efficient driving of the subject vehicle becomes possible. For example, high speed driving, driving with large acceleration/deceleration, and driving with a large yaw rate may be allowable, and the priority may be given to shortening the driving time to the destination.

When it is determined that a monitoring driver is disposed in the vehicle but no passenger is disposed, the allowance degree change unit 122 may preferably narrow the driving allowance degree compared to when it is determined that no monitoring driver and no passenger are disposed in the vehicle. The transport target specifying unit 104 specifies whether or not a monitoring driver and a passenger are disposed in the vehicle. According to this feature, even if there are no passenger, if a monitoring driver is disposed in the vehicle, it is possible to reduce the burden on the monitoring driver caused by the driving control of the vehicle.

It may be preferable that the allowance degree change unit 122 makes it more likely that the emergency braking will occur when it determines that neither a monitoring driver nor a passenger is disposed in the vehicle than when it determines that at least either one of the monitoring driver and the passenger is disposed in the vehicle. When neither a monitoring driver nor a passenger is disposed in the vehicle, it is not necessary to take into consideration the burden on the occupant caused by the driving control of the vehicle, as compared to when at least either one of the monitoring driver and the passenger is disposed in the vehicle. Therefore, stronger emergency braking is possible only in a situation where the burden on the occupant caused by sudden braking does not need to be taken into consideration. As a result, higher quality services can be provided. The emergency brake is a sudden braking by AEB (i.e., Automatic Emergency Braking) control for obstacle avoidance. Making emergency braking easier to occur includes making the timing at which the emergency braking begins earlier.

When it is determined that n occupant is disposed in the vehicle, the allowance degree change unit 122 may not preferably allow a lane change to allow the passenger transport vehicle to overtake. A lane change for overtaking will be referred to as an overtaking lane change hereinafter. The term “not allowed” here refers to not allowing the vehicle to pass unless there is no other way to reach the destination other than the overtaking lane change to pass. On the other hand, when it is determined that no occupant is disposed in the vehicle, the allowance degree change unit 122 may allow the passenger transport vehicle to execute an overtaking lane change. The overtaking indicates passing another vehicle ahead. The overtaking lane change may be less necessary than changing lanes to turn right or left. According to the above configuration, when an occupant is disposed in the vehicle, it is possible to avoid making a lane change, which has less necessity but would be a burden on the occupant. As a result, it becomes possible to provide high quality services. On the other hand, if no occupant is disposed in the vehicle, the vehicle can be allowed to execute the overtaking lane change, so that the vehicle reaches its destination more quickly. The allowance degree change unit 122 may be configured not to allow the passenger transport vehicle to execute the overtaking lane change when it is determined that a passenger is disposed in the vehicle. On the other hand, when the allowance degree change unit 122 specifies the presence of a monitoring driver, the allowance degree change unit 122 may allow the passenger transport vehicle to execute the overtaking lane change.

When it is determined that no occupant is disposed in the vehicle, the allowance degree change unit 122 may preferably drive the vehicle at a slower speed than when it is determined that an occupant is disposed in the vehicle. This makes it easier for an occupant who want to use the passenger transport vehicle to find the passenger transport vehicle. As a result, when there is no occupant in the vehicle, it becomes easier to secure a new occupant. The allowance degree change unit 122 may be configured to drive the vehicle at a slower speed when it is determined that no passenger is disposed in the vehicle than when it is determined that a passenger is disposed in the vehicle. In this case, the transport target specifying unit 104 may specify independently whether or not a monitoring driver and a passenger are disposed in the vehicle.

The HCU communication unit 105 executes an output process of the information to the HCU 20 and an acquisition process of the information from the HCU 20. The HCU communication unit 105 acquires information on images captured by the vehicle compartment camera 19, and the like. The HCU communication unit 105 has a vehicle compartment notification processing unit 151 and a vehicle outside notification processing unit 152 as sub-functional blocks. The vehicle compartment notification processing unit 151 indirectly controls the notification by the vehicle compartment notification device 17 by transmitting an instruction to the HCU 20. That is, the vehicle compartment notification processing unit 151 issues a notification to the occupant of the vehicle. The notification directed to the vehicle occupants is defined as a vehicle compartment notification. The vehicle outside notification processing unit 152 indirectly controls the notification by the vehicle outside notification device 18 by transmitting an instruction to the HCU 20. That is, the vehicle outside notification processing unit 152 issues a notification to the outside of the vehicle. A notification directed to the outside of the vehicle is defined as a vehicle outside notification.

It may be preferable that the vehicle compartment notification processing unit 151 issues a prompt notification as a vehicle compartment notification when the transport target specifying unit 104 specifies that a monitoring driver is disposed in the vehicle but no passenger is disposed in the vehicle. The prompt notification is a notification that prompts the monitoring driver to execute the driving operation and check the passenger transport vehicle. For example, the notification prompting the vehicle check may be a notification prompting the driver to execute the driving operation of the passenger transport vehicle to a location where the vehicle check is possible and to check the vehicle at that location. The vehicle check may include the check of the function of the accelerator and brakes. According to the above configuration, it is possible to complete the vehicle check before a passenger is disposed in the vehicle. In addition, by not prompting the monitoring driver to execute the driving operation when a passenger is disposed in the vehicle, it is possible to prevent the passenger transport vehicle from being mistaken for having a malfunction. The prompt notification may be executed by display or by sound output.

When the transport target specifying unit 104 specifies that no occupant is disposed in the vehicle, the vehicle outside notification processing unit 152 may preferably execute an unmanned notification as the vehicle outside notification. An unmanned notification is a notification that indicates that a passenger transport vehicle is autonomously driving without any occupants. This makes it possible to inform people around the vehicle that the vehicle may behave more quickly than when there is an occupant in the vehicle.

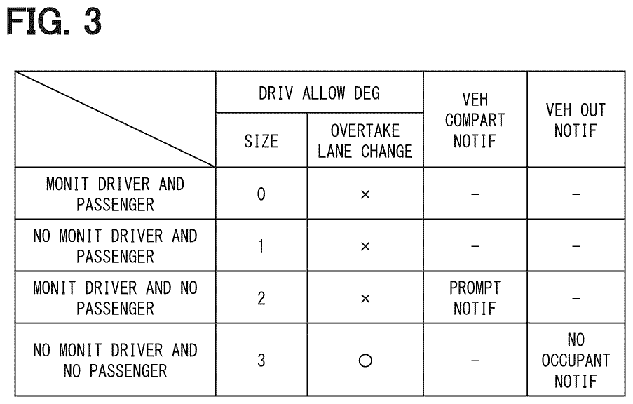

Here, an example of the feature of the driving allowance degree, the vehicle compartment notification, and the vehicle outside notification depending on the presence or absence of an occupant in the vehicle will be described with reference to the table of FIG. 3. In FIG. 3, the width of the driving allowance degree is indicated by a larger value as the range of allowable driving control becomes wider. Specifically, the driving allowance degrees are indicated in order from widest to narrowest as 3, 2, 1, and 0. As shown in FIG. 3, when a monitoring driver and a passenger are disposed in the vehicle, the driving allowance degree is set to the narrowest level of “0”. If there is no monitoring driver but there is a passenger in the vehicle, the next narrowest driving allowance degree is set to “1”. When there is a monitoring driver in the vehicle but no passengers in the vehicle, the driving allowance degree is set to a broader level of “2”. When there is no monitoring driver an no passenger, the driving allowance degree is set to the broadest level of “3”. Also, if there is no monitoring driver and no passenger in the vehicle, the overtake lane change is allowable. On the other hand, if at least one of a monitoring driver and a passenger is disposed in the vehicle, the overtake lane change is not allowed. Alternatively, the greater the driving allowance degree, the more likely it is that emergency braking will occur. For example, the vehicle may be driven at a higher speed as the driving allowance degree increases. As shown in FIG. 3, when there is a monitoring driver but no passenger in the vehicle, a prompt notification is made as a vehicle compartment notification. In addition, when there is no monitoring driver and no passenger in the vehicle, an unmanned notification is made as a vehicle outside notification.

### Second Embodiment

The present disclosure is not limited to the configuration described in the above embodiment, but can also adopt the following configuration as a second embodiment. The following will describe an example of a configuration of the second embodiment with reference to the drawings.

<Schematic Configuration of Vehicle System 1a>

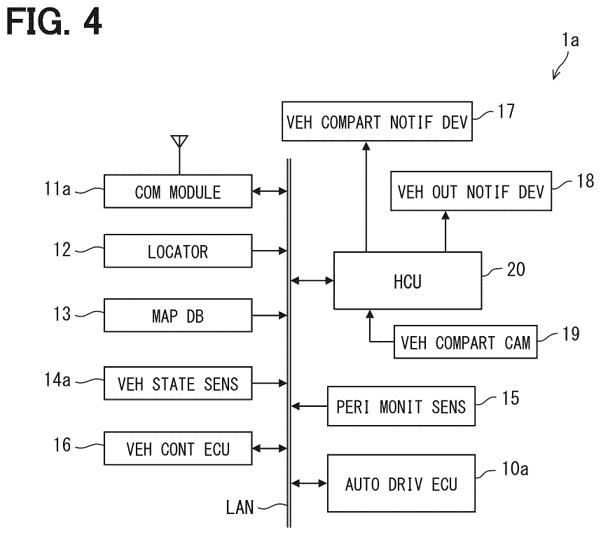

The vehicle system 1a shown in FIG. 4 can be used in a baggage transport vehicle among service vehicles. As described above, the baggage transport vehicle is a truck, a delivery vehicle, a postal vehicle, or the like. In this embodiment, an example will be described in which a baggage transport vehicle executes the autonomous driving of LV4 or higher. In addition, if the baggage transport vehicle is a vehicle that requires a driver to be on the vehicle, it may be configured to execute the autonomous driving at level LV1 or higher. In addition, if the baggage transport vehicle is a vehicle that requires a monitoring driver to be on the vehicle, it may be configured to execute the autonomous driving of LV3 or higher.

As shown in FIG. 4, the vehicle system 1a includes an autonomous driving ECU 10a, a communication module 11, a locator 12, a map DB 13, a vehicle state sensor 14a, a periphery monitoring sensor 15, a vehicle control ECU 16, a vehicle compartment notification device 17, a vehicle outside notification device 18, a vehicle compartment camera 19, and an HCU 20. The vehicle system 1a includes an autonomous driving ECU 10a instead of the autonomous driving ECU 10. The vehicle system 1a includes a vehicle state sensor 14a instead of the vehicle state sensor 14. The vehicle system 1a is similar to the vehicle system 1 of the first embodiment except for these points.

The communication module 11a is similar to the communication module 11 of the first embodiment except that some processes are different. This different point will be described below. The communication module 11a receives baggage information (described later) from a center that manages the collection and delivery of baggage (hereinafter, a collection and delivery management center) via wide area communication.

The vehicle state sensor 14a is similar to the vehicle state sensor 14 of the first embodiment, except for some differences in the sensor system. This different point will be described below. The vehicle state sensor 14a may include a pressure sensor provided in a space in the vehicle where the baggage is placed (hereinafter, referred to as baggage space). The pressure sensor may detect whether or not the baggage is disposed in the baggage space.

<Schematic Configuration of Autonomous Driving ECU 10a>

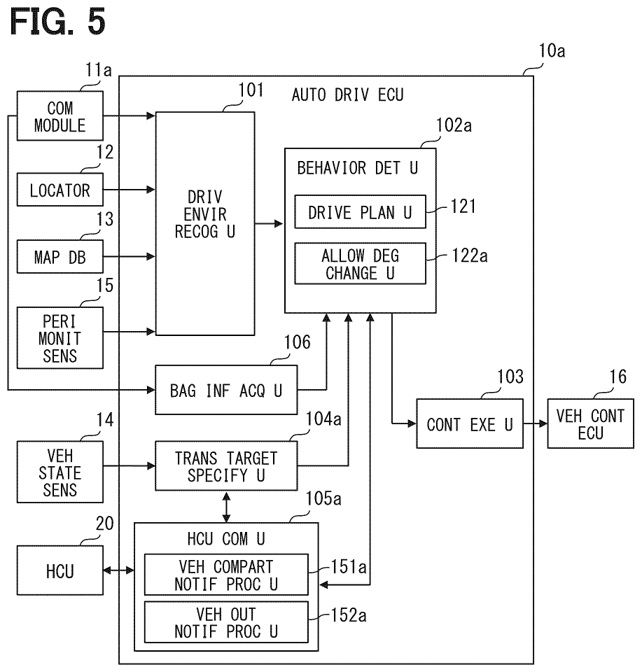

Next, a schematic configuration of the autonomous driving ECU 10a will be described with reference to FIG. 5. The autonomous driving ECU 10a is similar to the autonomous driving ECU 10 of the first embodiment, except for some differences in processing. The autonomous driving ECU 10a has a driving environment recognition unit 101, a behavior determination unit 102a, a control execution unit 103, a transport target specifying unit 104a, an HCU communication unit 105a, and a baggage information acquisition unit 106 as functional blocks. The autonomous driving ECU 10a includes a behavior determination unit 102a instead of the behavior determination unit 102. The autonomous driving ECU 10a is equipped with a transport target specifying unit 104a instead of the transport target specifying unit 104. The autonomous driving ECU 10a is equipped with an HCU communication unit 105a instead of the HCU communication unit 105. The autonomous driving ECU 10a is equipped with a baggage information acquisition unit 106. Except for these points, the autonomous driving ECU 10a is similar to the autonomous driving ECU 10 of the first embodiment. The autonomous driving ECU 10a also corresponds to the vehicle control device. The execution of the processes of the functional blocks of the autonomous driving ECU 10a by the computer corresponds to execution of a vehicle control method.

The baggage information acquisition unit 106 acquires information regarding precautions for transporting baggage to be transported by a baggage transport vehicle (hereinafter, baggage information). The baggage information may include baggage type information that can at least distinguish whether the baggage is fragile or not. The baggage information may also include information such as the desired delivery date and time of the baggage and whether or not it is express delivery. The baggage information acquisition unit 106 may acquire the baggage information from the baggage collection and delivery center via the communication module 11a. The baggage collection and delivery center manages the baggage information inputted by a baggage delivery requester via a terminal or the like, for example.

The transport target specifying unit 104a specifies whether or not there is baggage in the baggage transport vehicle. The processing in the transport target specifying unit 104a corresponds to a transport target specifying step. The transport target specifying unit 104a may specify whether or not the baggage is disposed in the baggage transport vehicle based on the sensing result of the pressure sensor. The transport target specifying unit 104a may specify the presence or absence of the baggage from an image captured by the vehicle compartment camera 19. In this case, the HCU 20 may execute image recognition of the baggage in the baggage space from the image captured by the vehicle compartment camera 19.

The behavior determination unit 102a includes a drive plan unit 121 and an allowance degree change unit 122a as sub-functional blocks. The allowance degree change unit 122a changes the driving allowance degree. The processing in the allowance degree change unit 122a also corresponds to the allowance degree change step.

The allowance degree change unit 122a changes the driving allowance degree depending on the specified result in the transport target specifying unit 104a. In other words, the driving allowance degree is changed depending on whether or not the baggage is disposed. This makes it possible to change the range of the driving control of the baggage transport vehicle that is allowable during the autonomous driving depending on whether or not the baggage is disposed in the baggage transport vehicle as the transport target. Therefore, it is possible to allow the driving control within a range appropriate to the presence or absence of the baggage, depending on whether or not there is the baggage in the vehicle. As a result, in the baggage transport vehicles that use the autonomous driving to transport the baggage as a service, it is possible to provide a high-quality service while reducing unnecessary control.

When the transport target specifying unit 104 specifies that no baggage is disposed in the vehicle, it may be preferable that the allowance degree change unit 122a widens the driving allowance degree compared to when the transport target specifying unit 104 specifies that the baggage is disposed in the vehicle. An example of widening the driving allowance degree may be the same as that described in the first embodiment. According to the above configuration, in a situation where the burden on the baggage caused by the driving control of the subject vehicle does not need to be taken into consideration, the driving control that prioritizes efficient driving of the subject vehicle becomes possible. For example, high speed driving, driving with large acceleration/deceleration, and driving with a large yaw rate may be allowable, and the priority may be given to shortening the driving time to the destination.

It may be preferable that the allowance degree change unit 122a does not allow the baggage transport vehicle to execute the overtake lane change when it determines that baggage is disposed in the vehicle. The term “not allowed” here may be the same as that described in the first embodiment. On the other hand, if it is determined that no baggage is disposed in the vehicle, the allowance degree change unit 122a may allow the baggage transport vehicle to execute the overtake lane change. According to the above configuration, when the baggage is disposed in the vehicle, it is possible to avoid making a lane change, which has less necessity but would be a burden on the baggage. As a result, it becomes possible to provide high quality services. On the other hand, if no baggage is disposed in the vehicle, the vehicle can be allowed to execute the overtaking lane change, so that the vehicle reaches its destination more quickly.

When it is determined that no baggage is disposed in the vehicle, the allowance degree change unit 122a may preferably control the vehicle to travel at a higher speed than when it is determined that baggage is disposed in the vehicle. The faster the vehicle travels, the more likely the vehicle is required to brake suddenly. In contrast, with the above configuration, when there is no baggage and no burden is placed on the baggage, traveling that prioritizes quickly reaching the destination is possible.

It may be preferable that the allowance degree change unit 122a changes the driving allowance degree in accordance with the baggage information acquired by the baggage information acquisition unit 106. This makes it possible to change the range of the driving control of a baggage transport vehicle that is allowed under the autonomous driving in accordance with precautions to be taken when transporting each type of baggage. As a result, it becomes possible to provide a higher quality of service. For example, the allowance degree change unit 122a may narrow the driving allowance degree when the baggage is fragile compared to when the baggage is not fragile. The allowance degree change unit 122a may determine whether the baggage is fragile or not from the baggage information. When there is little time left for the delivery date and time, the allowance degree change unit 122a may set the driving allowance degree to be wider than when there is much time left for the delivery date and time. The allowance degree change unit 122a may determine from the baggage information whether there is little time left for the delivery date and time. As one example, whether the time remaining until the delivery date and time is short or not may be determined based on whether the time remaining until the delivery date and time is equal to or less than a threshold value.

The HCU communication unit 105a has a vehicle compartment notification processing unit 151a and a vehicle outside notification processing unit 152a as sub-functional blocks. The vehicle compartment notification processing unit 151a is similar to the vehicle compartment notification processing unit 151 of the first embodiment, except that it does not execute a prompt notification. When the transport target specifying unit 104a specifies that no baggage is disposed in the vehicle, the vehicle outside notification processing unit 152 issues a no-load notification as the vehicle outside notification. The no-load notification is a notification that indicates that the baggage transport vehicle is automatically driving without any baggage. This makes it possible to inform people around the vehicle that the vehicle may behave more quickly than when there is the baggage in the vehicle.

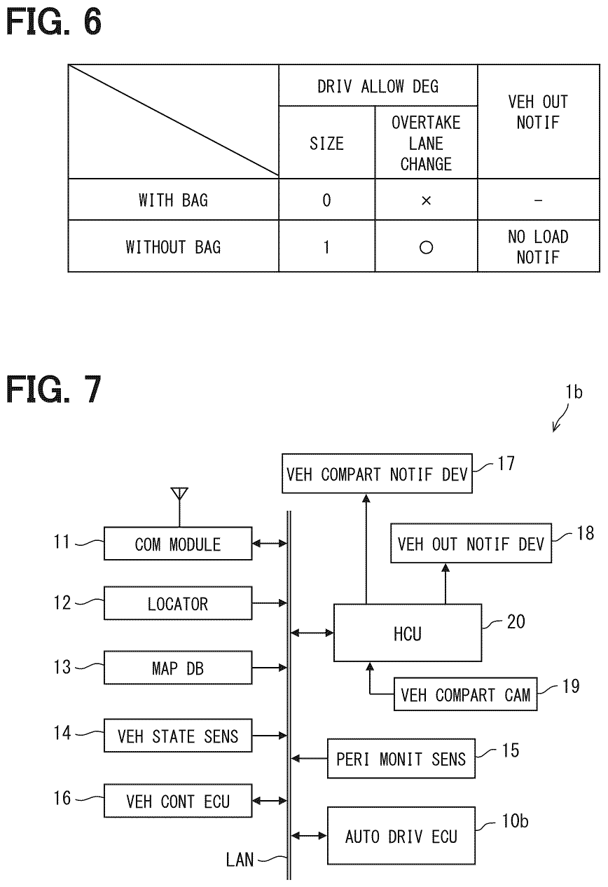

Here, an example of the driving allowance degree and the feature of the vehicle outside notification depending on the presence or absence of the baggage will be described with reference to the table of FIG. 6. In FIG. 6, the width of the driving allowance degree is indicated by a larger value as the range of allowable driving control becomes wider. Specifically, the driving allowance degrees are indicated in order from widest to narrowest as 1, and 0. Here, these numerical values do not necessarily represent the same range as that explained in the first embodiment with reference to FIG. 3. As shown in FIG. 6, when there is the baggage in the vehicle, the driving allowance degree is set to the narrowest value of “0”. When there is no baggage, the driving allowance degree is set to a broader value of “1”. Alternatively, the greater the driving allowance degree, the more likely it is that emergency braking will occur. As shown in FIG. 6, when there is no baggage, a no-load notification is issued as the notification outside the vehicle.

### Third Embodiment

The present disclosure is not limited to the configuration described in the above embodiment, but can also adopt the following configuration as a third embodiment. The following feature will be described as an example of a configuration of the third embodiment with reference to the accompanying drawings.

<Schematic Configuration of Vehicle System 1b>

The vehicle system 1b shown in FIG. 7 can be used in both the passenger transport vehicle and the baggage transport vehicle among the service vehicles. Here, as an example, a case where the system is used in a passenger transport vehicle will be described.

As shown in FIG. 7, the vehicle system 1b includes an autonomous driving ECU 10b, a communication module 11, a locator 12, a map DB 13, a vehicle state sensor 14, a periphery monitoring sensor 15, a vehicle control ECU 16, a vehicle compartment notification device 17, a vehicle outside notification device 18, a vehicle compartment camera 19, and an HCU 20. A vehicle system 1b of the ninth embodiment is similar to the vehicle system 1 of the first embodiment, except that the vehicle system 1b includes an autonomous driving ECU 10b instead of the autonomous driving ECU 10. When the vehicle system 1b is used in a baggage transport vehicle, the following procedure may be adopted. A vehicle system 1b of the third embodiment is similar to the vehicle system 1a of the second embodiment, except that the vehicle system 1b includes an autonomous driving ECU 10b instead of the autonomous driving ECU 10a.

<Schematic Configuration of Autonomous Driving ECU 10b>

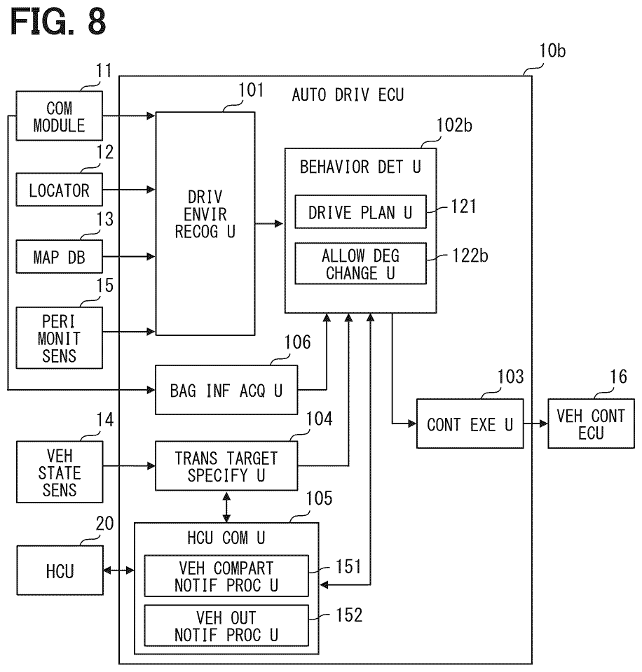

Next, a schematic configuration of the autonomous driving ECU 10b will be described with reference to FIG. 8. The autonomous driving ECU 10b is similar to the autonomous driving ECU 10 of the first embodiment, except for some differences in processing. The autonomous driving ECU 10b has a driving environment recognition unit 101, a behavior determination unit 102b, a control execution unit 103, a transport target specifying unit 104, and an HCU communication unit 105 as functional blocks. The autonomous driving ECU 10b is similar to the autonomous driving ECU 10 of the first embodiment, except that the autonomous driving ECU 10b includes a behavior determination unit 102b instead of the behavior determination unit 102. The autonomous driving ECU 10b also corresponds to the vehicle control device. The execution of the processes of the functional blocks of the autonomous driving ECU 10b by the computer corresponds to execution of a vehicle control method. When the vehicle system 1b is used in a baggage transport vehicle, the following procedure may be adopted. The autonomous driving ECU 10b is similar to the autonomous driving ECU 10a of the second embodiment, except that the autonomous driving ECU 10b includes a behavior determination unit 102b instead of the behavior determination unit 102a.

The behavior determination unit 102b includes a drive plan unit 121 and an allowance degree change unit 122b as sub-functional blocks. The allowance degree change unit 122b changes the driving allowance degree. The processing in the allowance degree change unit 122b also corresponds to the allowance degree change step. The allowance degree change unit 122b is similar to the allowance degree change unit 122 except for some differences in the processing. This different processing will be described below.

When it is determined that a transport target is not disposed in the vehicle, the allowance degree change unit 122b may preferably allow the overtaking lane change more times than when it is determined that a transport target is disposed in the vehicle. When the vehicle system 1b is used in a passenger transport vehicle, the following procedure may be adopted. When it is determined that no occupant is disposed in the vehicle, the allowance degree change unit 122b may increase the number of times that the passenger transport vehicle is allowed to execute the overtaking lane change compared to when it is determined that an occupant is disposed in the vehicle. When the vehicle system 1b is used in a baggage transport vehicle, the following procedure may be adopted. When it is determined that no baggage is disposed in the vehicle, the allowance degree change unit 122b may increase the number of times that the baggage transport vehicle is allowed to execute the overtaking lane change to pass compared to when it is determined that baggage is disposed in the vehicle. According to the above configuration, when a transport target is disposed in the vehicle, it is possible to reduce the number of lane changes, which are unlikely to be necessary but may place a burden on the transport target. As a result, it becomes possible to provide high quality services. On the other hand, if there is no transport target in the vehicle, the number of times of executing the overtaking lane changes can be increased, so that the vehicle can reach the destination more quickly. When the vehicle system 1b is used in a baggage transport vehicle, the following procedure may be adopted. The allowance degree change unit 122b may be similar to the allowance degree change unit 122a of the second embodiment, except for some of the above-described different processing.

### Fourth Embodiment

The present disclosure is not limited to the configuration described in the above embodiment, but can also adopt the following configuration as a fourth embodiment. The following will describe a detailed example of the fourth embodiment with reference to the accompanying drawings.

<Schematic Configuration of Vehicle System 1c>

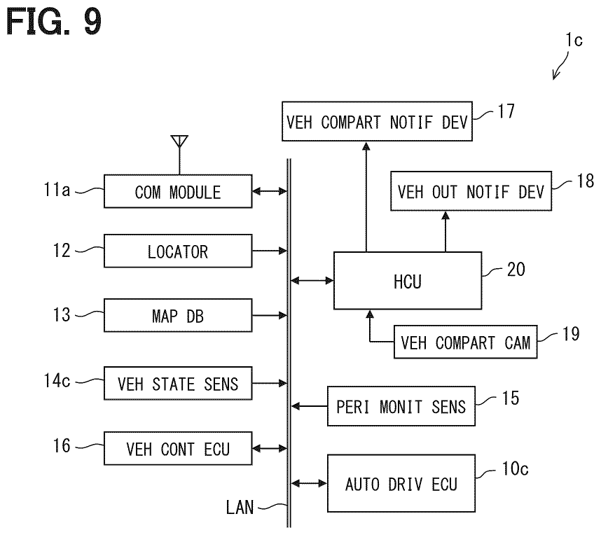

The vehicle system 1c shown in FIG. 9 can be used in a service vehicle that transports both occupants and baggage. Such service vehicles are defined as passenger and baggage mixture transport vehicles. The passenger and baggage mixture transport vehicle may transport only a passenger, only baggage, or both a passenger and baggage. In addition, the service vehicles that transport both occupants and baggage may also include baggage transport vehicles in which a monitoring driver rides. In this embodiment, an example will be described in which a passenger and baggage mixture transport vehicle executes the autonomous driving of LV4 or higher. In addition, if the passenger and baggage mixture transport vehicle is a vehicle that requires a monitoring driver to be on the vehicle, it may be configured to execute the autonomous driving of LV3 or higher.

As shown in FIG. 9, the vehicle system 1c includes an autonomous driving ECU 10c, a communication module 11a, a locator 12, a map DB 13, a vehicle state sensor 14a, a periphery monitoring sensor 15, a vehicle control ECU 16, a vehicle compartment notification device 17, a vehicle outside notification device 18, a vehicle compartment camera 19, and an HCU 20. The vehicle system 1c includes an autonomous driving ECU 10c instead of the autonomous driving ECU 10. The vehicle system 1c includes the communication module 11a instead of the communication module 11. The vehicle system 1c includes a vehicle state sensor 14a instead of the vehicle state sensor 14. The vehicle system 1c is similar to the vehicle system 1 of the first embodiment except for these points. The communication module 11a is similar to the communication module 11a of the second embodiment. The vehicle state sensor 14a is similar to the vehicle state sensor 14a of the second embodiment.

<Schematic Configuration of Autonomous Driving ECU 10c>

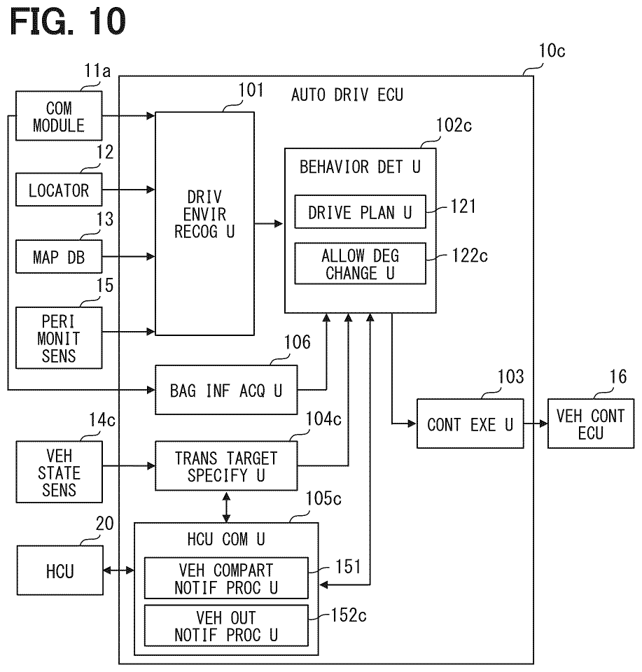

Next, a schematic configuration of the autonomous driving ECU 10c will be described with reference to FIG. 10. The autonomous driving ECU 10c is similar to the autonomous driving ECU 10 of the first embodiment, except for some differences in processing. The autonomous driving ECU 10c has a driving environment recognition unit 101, a behavior determination unit 102c, a control execution unit 103, a transport target specifying unit 104c, an HCU communication unit 105c, and a baggage information acquisition unit 106 as functional blocks. The autonomous driving ECU 10c includes a behavior determination unit 102c instead of the behavior determination unit 102. The autonomous driving ECU 10c is equipped with a transport target specifying unit 104c instead of the transport target specifying unit 104. The autonomous driving ECU 10c is equipped with an HCU communication unit 105c instead of the HCU communication unit 105. The autonomous driving ECU 10c is equipped with a baggage information acquisition unit 106. Except for these points, the autonomous driving ECU 10c is similar to the autonomous driving ECU 10 of the first embodiment. The autonomous driving ECU 10c also corresponds to the vehicle control device. The execution of the processes of the functional blocks of the autonomous driving ECU 10c by the computer corresponds to execution of a vehicle control method.

The baggage information acquisition unit 106 is similar to the package information acquisition unit 106 in the second embodiment. The transport target specifying unit 104c distinguishes and specifies whether or not each of the occupant and the baggage is disposed in the passenger and baggage mixture transport vehicle. The processing in the transport target specifying unit 104c corresponds to a transport target specifying step. The transport target specifying unit 104c may specify whether or not a passenger is disposed in the occupant and baggage mixture transport vehicle in the same manner as the transport target specifying unit 104 in the first embodiment. The transport target specifying unit 104c may specify whether or not the baggage is disposed in the passenger and baggage mixture transport vehicle in the same manner as the transport target specifying unit 104a in the second embodiment.

The behavior determination unit 102c includes a drive plan unit 121 and an allowance degree change unit 122c as sub-functional blocks. The allowance degree change unit 122c may be similar to the allowance degree change unit 122, except for some differences in the processing. This different point will be described below. The processing in the allowance degree change unit 122c also corresponds to the allowance degree change step.

The allowance degree change unit 122c changes the driving allowance degree depending on the specified result in the transport target specifying unit 104c. The allowance degree change unit 122c changes the driving allowance degree depending on whether or not at least one of an occupant and the baggage is disposed in the vehicle. This makes it possible to change the range of the driving control of a passenger and baggage mixture transport vehicle that is allowed during the autonomous driving depending on whether or not there is a transport target in the passenger and baggage mixture transport vehicle. Therefore, it is possible to allow the driving control in a range that is appropriate for the presence or absence of a transport target, according to the presence or absence of a transport target. As a result, in the passenger and baggage mixture transport vehicle that uses the autonomous driving to transport the baggage as a service, it is possible to provide a high-quality service while reducing unnecessary control.

It may be preferable that the allowance degree change unit 122c changes the driving allowance degree according to the combination of the results of specifying whether or not there is an occupant in the vehicle and whether or not there is baggage in the vehicle. This makes it possible to allow the driving control within a range appropriate to the combination of whether or not an occupant and/or baggage is disposed in the vehicle. As a result, in the passenger and baggage mixture transport vehicle for transporting the baggage as a service using the autonomous driving, it is possible to provide a higher quality of service while reducing unnecessary control.

When it is determined that no occupant or baggage is disposed in the vehicle, the allowance degree change unit 122c may preferably set the driving allowance degree to be wider than when it is determined that both of an occupant and baggage are disposed in the vehicle. When it is determined that either one of an occupant or baggage is disposed in the vehicle, the allowance degree change unit 122c may preferably set the driving allowance degree to be wider than when it is determined that both of an occupant and baggage are disposed in the vehicle. The presence of either one of the occupant or the baggage indicates that only either an occupant or baggage is disposed in the vehicle. When it is determined that both of an occupant or baggage is not disposed in the vehicle, the allowance degree change unit 122c may preferably set the driving allowance degree to be wider than when it is determined that either one of an occupant or baggage is disposed in the vehicle. An example of widening the driving allowance degree may be the same as that described in the first embodiment. According to the above configuration, the fewer the targets for which the burden caused by the driving control needs to be considered, the more the driving control that prioritizes efficient driving of the subject vehicle becomes possible. On the other hand, the more targets for which the burden caused by the driving control must be taken into consideration, the more the driving control can be executed with reduced burden caused by the driving control. As a result, in the passenger and baggage mixture transport vehicle for transporting the baggage as a service using the autonomous driving, it is possible to provide a higher quality of service while reducing unnecessary control.

The allowance degree change unit 122c may make it easier to apply emergency braking when it is determined that no occupant or baggage is disposed in the vehicle, compared to when it is determined that either one of the occupant and the baggage is disposed in the vehicle. Thus, it is possible to apply stronger emergency braking only in a situation where the burden on an occupant and baggage caused by sudden braking does not need to be taken into consideration. As a result, higher quality services can be provided.

The allowance degree change unit 122c may change the number of allowance times to execute the overtake lane change depending on the combination of the results of specifying whether or not there is an occupant in the vehicle and whether or not there is baggage in the vehicle. When it is determined that no occupant or baggage is disposed in the vehicle, the allowance degree change unit 122c may preferably set the number of allowance times of the overtake lane change to be higher than when it is determined that both of a occupant and baggage are disposed in the vehicle. When it is determined that either one of an occupant or baggage is disposed in the vehicle, the allowance degree change unit 122c may preferably set the number of allowance times of the overtake lane change to be higher than when it is determined that both of an occupant and baggage are disposed in the vehicle. When it is determined that no occupant or baggage is disposed in the vehicle, the allowance degree change unit 122c may preferably set the number of allowance times of the overtake lane change to be higher than when it is determined that either one of a occupant and baggage is disposed in the vehicle. According to the above configuration, the more the targets for which the burden caused by the driving control needs to be considered, the more it is possible to reduce the number of lane changes that are less necessary but place a burden on the transport targets. As a result, it becomes possible to provide high quality services. On the other hand, the fewer the targets that need to be considered in terms of the burden caused by the driving control, the more quickly the vehicle can reach the destination by increasing the number of times for the overtake lane changes.

The HCU communication unit 105c has a vehicle compartment notification processing unit 151 and a vehicle outside notification processing unit 152c as sub-functional blocks. The HCU communication unit 105c is similar to the HCU communication unit 105 of the first embodiment, except that the HCU communication unit 105c has a vehicle outside notification processing unit 152c instead of the vehicle outside notification processing unit 152. When the transport target specifying unit 104c specifies that no occupant or baggage is disposed in the vehicle, the vehicle outside notification processing unit 152c issues an unmanned and unloaded notification as a vehicle outside notification. The unmanned and un-loaded notification is a notification that indicates that a passenger and baggage mixture transport vehicle is traveling autonomously with no occupant and no baggage. This makes it possible to inform people around the vehicle that the vehicle may behave more quickly than when there is the baggage and/or the occupant in the vehicle.

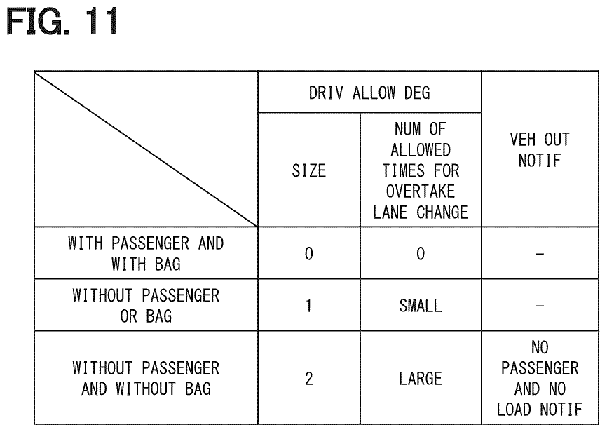

Here, an example of the driving allowance degree and the feature of the vehicle outside notification depending on the presence or absence of each of the baggage and the occupant will be described with reference to the table of FIG. 11. In FIG. 11, the width of the driving allowance degree is indicated by a larger value as the range of allowable driving control becomes wider. Specifically, the driving allowance degrees are indicated in order from widest to narrowest as 2, 1, and 0. Here, these numerical values do not necessarily represent the same range as that explained in the first embodiment with reference to FIG. 3. As shown in FIG. 11, when there are both of the baggage and the occupant in the vehicle, the driving allowance degree is set to the narrowest level of “0”. The number of allowance times of the overtake lane changes is set to, for example, “0”. When there is either one of the baggage and the occupant in the vehicle, the driving allowance degree is set to the second narrowest level of “1”. The number of allowance times of the overtake lane changes is set to, for example, “0” or more, which is a small number. In this case, “a small number” indicates the number smaller than the amount when there are no occupant and no baggage in the vehicle. When there are no baggage and no occupant in the vehicle, the driving allowance degree is set to a broader value of “1”. In addition, the number of allowance times of the overtake lane change is set to be greater than when there is either one of the baggage and the occupant in the vehicle. Alternatively, the greater the driving allowance degree, the more likely it is that emergency braking will occur. For example, the vehicle may be driven at a higher speed as the driving allowance degree increases. As shown in FIG. 11, when there is no baggage and no occupant in the vehicle, a unmanned and un-loaded notification is issued as the notification outside the vehicle.

### Fifth Embodiment

The present disclosure is not limited to the configuration described in the above embodiment, but can also adopt the following configuration as a fifth embodiment. The following will describe a detailed example of the fifth embodiment with reference to the accompanying drawings.

<Schematic Configuration of Vehicle System 1d>

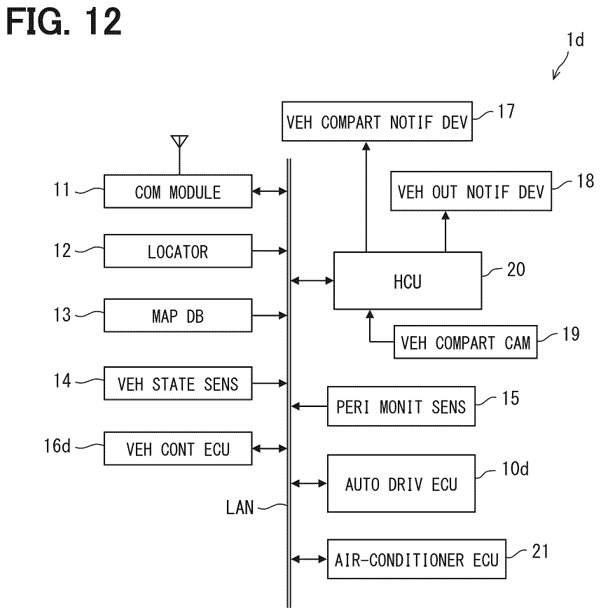

A vehicle system 1d shown in FIG. 12 can be used in a service vehicle. The service vehicle may be any of a passenger transport vehicle, a baggage transport vehicle, and a passenger and baggage mixture transport vehicle. In this embodiment, an example will be described in which a service vehicle executes the autonomous driving of LV4 or higher. In addition, if the service vehicle is a vehicle that requires a monitoring driver to be on the vehicle, it may be configured to execute the autonomous driving of LV3 or higher.

As shown in FIG. 12, the vehicle system 1d includes an autonomous driving ECU 10d, a communication module 11, a locator 12, a map DB 13, a vehicle state sensor 14, a periphery monitoring sensor 15, a vehicle control ECU 16d, a vehicle compartment notification device 17, a vehicle outside notification device 18, a vehicle compartment camera 19, and an air conditioner HCU 21. The vehicle system 1d includes an autonomous driving ECU 10d instead of the autonomous driving ECU 10. The vehicle system 1d includes an air conditioner ECU 21. The vehicle system 1d is similar to the vehicle system 1 of the first embodiment except for these points.

The vehicle control ECU 16d is similar to the vehicle control ECU 16 of the first embodiment, except for some differences in processing. This different point will be described below. During the autonomous driving, the vehicle control ECU 16d may preferably operates the steering wheel in accordance with the turning operation of the autonomous driving as a default steering control. Hereinafter, the operation of the steering wheel in accordance with the turning operation of the autonomous driving will be referred to as a pseudo operation. In addition, the vehicle control ECU 16d is also capable of restricting the pseudo operation during the autonomous driving. An example of a restriction on the pseudo operation is not to execute the pseudo operation. In other words, the steering wheel may be fixed regardless of whether the turning operation of the autonomous driving is executed. An example of a restriction on the pseudo operation is to reduce the amount of the pseudo operation.

The air conditioner ECU 21 is an electronic control device that controls the operation of the air conditioner of the service vehicle. The air conditioner generates conditioned air to be blown into the passenger compartment of the service vehicle. The conditioned air includes hot air and cold air.

<Schematic Configuration of Autonomous Driving ECU 10d>

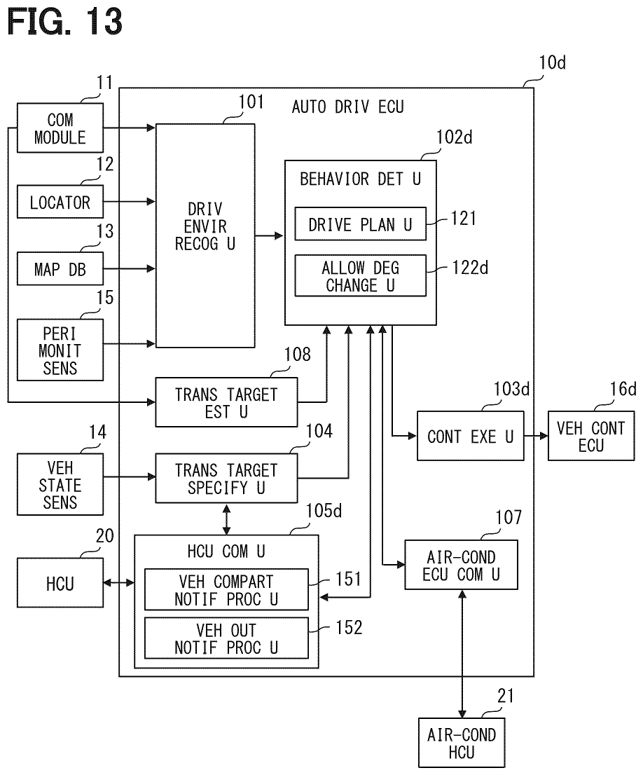

Next, a schematic configuration of the autonomous driving ECU 10d will be described with reference to FIG. 13. The autonomous driving ECU 10d is similar to the autonomous driving ECU 10 of the first embodiment, except for some differences in processing. The autonomous driving ECU 10d has a driving environment recognition unit 101, a behavior determination unit 102d, a control execution unit 103d, a transport target specifying unit 104, an HCU communication unit 105d, and an air conditioner ECU 107 and a transport target estimation unit 108 as functional blocks. The autonomous driving ECU 10d includes a behavior determination unit 102d instead of the behavior determination unit 102. The autonomous driving ECU 10d includes a control execution unit 103d instead of the control execution unit 103. The autonomous driving ECU 10d is equipped with an HCU communication unit 105d instead of the HCU communication unit 105. The autonomous driving ECU 10d is equipped with an air conditioner ECU communication unit 107 and a transport target estimation unit 108. Except for these points, the autonomous driving ECU 10d is similar to the autonomous driving ECU 10 of the first embodiment. The autonomous driving ECU 10d also corresponds to the vehicle control device. The execution of the processes of the functional blocks of the autonomous driving ECU 10d by the computer corresponds to execution of a vehicle control method.

The control execution unit 103d is similar to the control execution unit 103 of the first embodiment, except for some differences in processing. This different point will be described below. It may be preferable that the control execution unit 103d is capable of switching whether or not to execute the above-described restriction of the pseudo operation.

The air conditioner communication unit 107 executes an output process of the information to the air conditioner HCU 21 and an acquisition process of the information from the air conditioner HCU 21. The air conditioner ECU communication unit 107 acquires information about the air conditioner from the air conditioner HCU 21. The information on the air conditioner includes the on/off status of the air conditioner, the setting values of the air conditioner, and the like. The air conditioner ECU communication unit 107 indirectly controls the air conditioner by transmitting an instruction to the air conditioner HCU 21. The air conditioner ECU communication unit 107 indirectly controls the air conditioner to turn on and off by transmitting an instruction to the air conditioner HCU 21.

The transport target estimation unit 108 estimates a change in the presence or absence of a transport target for the subject vehicle. It may be preferable that the transport target estimation unit 108 estimates the timing when there will be a change in the presence or absence of the transport target. The transport target estimation unit 108 may acquire information on the getting on and off schedule via the communication module 11, for example, from a center that manages the getting on and off schedule of the transport target. Then, based on the acquired information of the getting on and off schedule, the timing of the change in the presence or absence of the transport target can be estimated. The transport target estimation unit 108 may acquire the information on the getting on and off schedule of the transport target from the above-described user input device, and estimate the timing of a change in the presence or absence of the transport target.

The behavior determination unit 102d includes a drive plan unit 121 and an allowance degree change unit 122d as sub-functional blocks. The allowance degree change unit 122d may be similar to the allowance degree change unit 122, except for some differences in the processing. This different point will be described below. The processing in the allowance degree change unit 122d also corresponds to the allowance degree change step.

When the transport target specifying unit 104 specifies that no transport target is disposed in the vehicle, the allowance degree change unit 122d may execute the following procedure. The allowance degree change unit 122d executes the vehicle control to improve the fuel efficiency performance of the subject vehicle, compared to when it is determined that a transport target is disposed in the vehicle. The vehicle control for improving the fuel efficiency performance of the subject vehicle will be referred to as fuel efficiency improvement control hereinafter. That is, the allowance degree change unit 122d changes, as the driving allowance degree, whether or not fuel efficiency improvement control is executed. This makes it possible to execute the fuel efficiency improvement control only in a case where there is no transport target in the subject vehicle and there is no need for vehicle control suitable for transporting the transport target. This makes it possible to provide high quality services while reducing fuel consumption.

Examples of the fuel efficiency improvement control include the following features. An example of the fuel efficiency improvement control is a control that allows a vehicle to follow a vehicle ahead. The follow-up driving refers to driving in which the subject vehicle follows the vehicle ahead while maintaining a target inter-vehicle distance according to the speed of the subject vehicle. This control may be executed by the control execution unit 103d. This control improves the fuel efficiency by reducing the air resistance of the subject vehicle caused by the presence of a vehicle ahead. An example of the fuel efficiency improvement control is a control that allows a vehicle to travel at a low and constant speed. The low speed may be equal to or lower than a predetermined speed. The predetermined speed may be set to any value that can be expected to reduce fuel consumption. This control may be executed by the control execution unit 103d. This control also improves the fuel efficiency. An example of the fuel efficiency improvement control is a control that allows a vehicle to turn off the air conditioner device. This control may be executed according to an instruction from the air conditioner ECU communication unit 107. This control also improves the fuel efficiency.

When the air conditioning system is turned off as the fuel efficiency improvement control and it is estimated that the state will transition to one in which a transport target to be disposed in the vehicle within a specific time, it may be preferable that the allowance degree change unit 122d executes the following feature. It may be preferable that the allowance degree change unit 122d executes the control to turn on the air conditioner or to open the windows of the vehicle. The transport target estimation unit 108 may estimate that the state of the vehicle will transition to a state where the transport target will be disposed in the vehicle within a predetermined time. “Within a predetermined time” refers to within a predetermined time from the present time. The predetermined time may be the time estimated to be required to adjust the air conditioning in the vehicle compartment to a temperature suitable for transporting the transport target by controlling to turn on the air conditioning device or open the vehicle windows. The predetermined time may be arbitrarily set. The control to turn on the air conditioning device may be executed according to an instruction from the air conditioner ECU communication unit 107. The control for opening the window of the vehicle can be executed by transmitting an instruction from the autonomous driving ECU 10d to an ECU that controls the opening and closing of the window.

According to the above configuration, when a transition from a state in which the transport target is not disposed in the vehicle to a state in which the transport target is disposed in the vehicle is estimated, it is possible to adjust the air conditioning in the vehicle compartment to a temperature suitable for transporting the transport target before the transition. As a result, it is possible to provide high quality services while reducing fuel consumption.

As the fuel efficiency improvement control, it may be preferable that the allowance degree change unit 122d executes the following feature when there is no vehicle behind the subject vehicle within a predetermined range. It may be preferable that the allowance degree change unit 122d make the amount of change in deceleration when stopping the subject vehicle smaller than the amount of change in deceleration when the vehicle behind the subject vehicle is disposed within a predetermined range. Examples of situations in which the vehicle must be stopped include stopping at a red light or at a stop line. The predetermined range referred to here may be arbitrarily set. The predetermined range may be, for example, the sensing range of the periphery monitoring sensor 15. In other words, the feature that a vehicle behind the subject vehicle is not disposed within a predetermined range, can be rephrased as the feature that the vehicle behind the subject vehicle cannot be detected by the periphery monitoring sensor 15. The feature that no vehicle behind the subject vehicle is disposed within a predetermined range may be recognized by the driving environment recognition unit 101. This control of the change amount of the deceleration may be executed by the control execution unit 103d. Reducing the amount of change in deceleration when stopping the subject vehicle can be rephrased to the providing of a margin of safety distance until the subject vehicle is stopped. Reducing the amount of change in deceleration when stopping the subject vehicle can be rephrased to the stopping of the subject vehicle more slowly than a case where the vehicle behind the subject vehicle is disposed within a predetermined range.

According to the above configuration, it is possible to improve the fuel efficiency performance by stopping the subject vehicle slowly only in a situation where the subject vehicle is unlikely to affect the driving of the vehicle behind the subject vehicle even if the subject vehicle stops slowly. When stopping the subject vehicle because of the obstacle in front of the subject vehicle, the allowance degree change unit 122d may set the range in which the change amount of the deceleration is reduced to be disposed within a range in which the subject vehicle can be stopped with a certain distance from the obstacle.

It may be preferable that the allowance degree change unit 122d restricts the above-described pseudo operation as the fuel efficiency improvement control. As described above, the restriction on the pseudo operation may be to reduce the amount of the pseudo operation or not to execute the pseudo operation. This makes it possible to reduce the fuel consumption due to the pseudo operation when there is no transport target in the vehicle and no occupant to watch the pseudo operation. As a result, it is possible to achieve the improvement of the fuel efficiency. When the pseudo operation is restricted, the transport target as the target of the pseudo operation may be at least the occupant out of the baggage and the occupant.

It may be preferable that the allowance degree change unit 122d restricts the display on a display device provided in the subject vehicle as the fuel efficiency improvement control. Examples of the display device include the above-described vehicle compartment display device and the vehicle outside display device. This makes it possible to reduce the fuel consumption caused by display on the display device and improve the fuel efficiency. The restriction of the display may be turning off of the display or reducing of the display brightness. The allowance degree change unit 122d may restrict the display on the display device via the HCU communication unit 105d. The allowance degree change unit 122d may be configured to restrict only the display on the vehicle compartment display device out of the vehicle compartment display device and the vehicle outside display device as the fuel efficiency improvement control. This makes it possible to restrict the display by focusing on the vehicle compartment display device, which would be unnecessary to display the information if no transport target is disposed in the vehicle, out of the vehicle compartment display device and the vehicle outside display device.

When the allowance degree change unit 122d executes the fuel efficiency improvement control, it may be preferable that the allowance degree change unit 122d executes the fuel efficiency improvement control at the following timing. It may be preferable that the allowance degree change unit 122d executes the fuel efficiency improvement control at the timing when a state in which it determines that a transport target is dispose din the vehicle is transitioned to a state in which it determines that a transport target is not disposed in the vehicle, and the vehicle starts travelling in a state in which it has been determined that a transport target is not disposed in the vehicle. The transport target specifying unit 104 may specify whether or not a transport target is disposed in the vehicle. According to the above configuration, it is possible to suppress unnecessary processing that occurs when the fuel efficiency improvement control is executed even if the subject vehicle is not travelling.

### Sixth Embodiment

The present disclosure is not limited to the configuration described in the above embodiment, but can also adopt the following configuration as a sixth embodiment. The following will describe a detailed example of the sixth embodiment with reference to the accompanying drawings.

<Schematic Configuration of Vehicle System 1e>

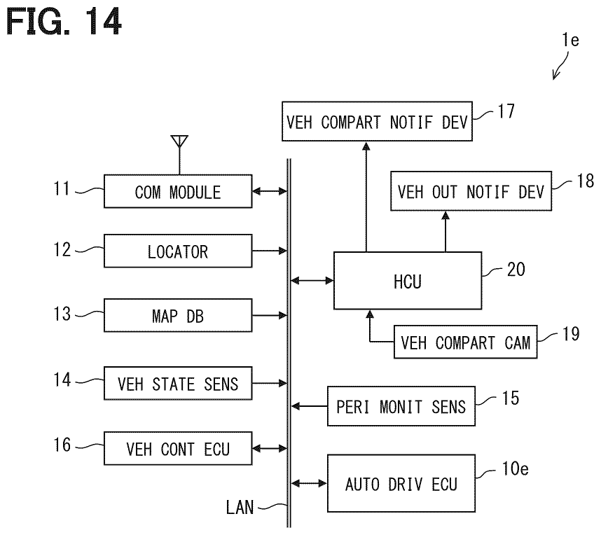

As shown in FIG. 14, the vehicle system 1e includes an autonomous driving ECU 10e, a communication module 11, a locator 12, a map DB 13, a vehicle state sensor 14, a periphery monitoring sensor 15, a vehicle control ECU 16, a vehicle compartment notification device 17, a vehicle outside notification device 18, a vehicle compartment camera 19, and an HCU 20. A vehicle system 1e of the ninth embodiment is similar to the vehicle system 1 of the first embodiment, except that the vehicle system 1e includes an autonomous driving ECU 10e instead of the autonomous driving ECU 10. The service vehicle using the vehicle system 1e may be any of a passenger transport vehicle, a baggage transport vehicle, and a passenger and baggage mixture transport vehicle.

<Schematic Configuration of Autonomous Driving ECU 10e>

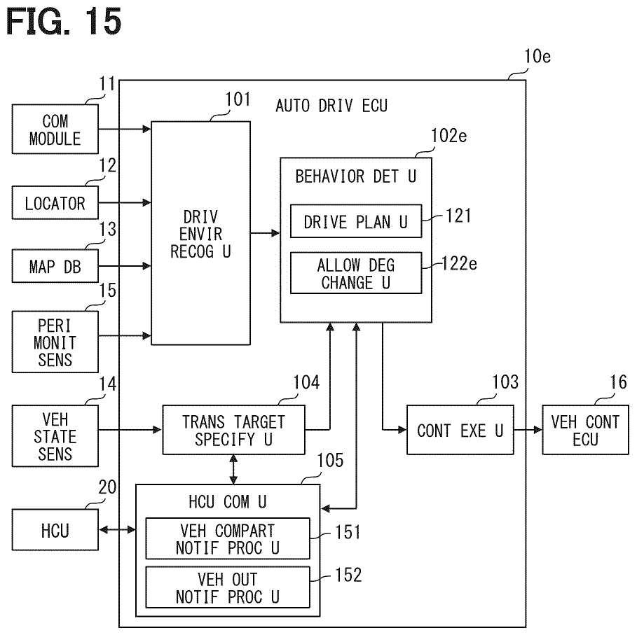

Next, a schematic configuration of the autonomous driving ECU 10e will be described with reference to FIG. 15. The autonomous driving ECU 10e is similar to the autonomous driving ECU 10 of the first embodiment, except for some differences in processing. The autonomous driving ECU 10e has a driving environment recognition unit 101, a behavior determination unit 102e, a control execution unit 103, a transport target specifying unit 104, and an HCU communication unit 105 as functional blocks. The autonomous driving ECU 10e is similar to the autonomous driving ECU 10 of the first embodiment, except that the autonomous driving ECU 10e includes a behavior determination unit 102e instead of the behavior determination unit 102. The autonomous driving ECU 10e also corresponds to the vehicle control device. The execution of the processes of the functional blocks of the autonomous driving ECU 10e by the computer corresponds to execution of a vehicle control method.

The behavior determination unit 102e includes a drive plan unit 121 and an allowance degree change unit 122e as sub-functional blocks. The allowance degree change unit 122e may be similar to the allowance degree change unit 122, except for some differences in the processing. This different point will be described below. The processing in the allowance degree change unit 122e also corresponds to the allowance degree change step.

When the transport target specifying unit 104 specifies that no transport target is disposed in the vehicle, the allowance degree change unit 122e allows the vehicle to travel on a narrower road than when the transport target specifying unit 104 specifies that the transport target is disposed in the vehicle. That is, the allowance degree change unit 122e changes, as the driving allowance degree, a road on which the vehicle is allowed to travel. When there is no transport target in the vehicle and no occupant in the vehicle, the occupant will not feel uneasy even if the vehicle is travelling on a narrower road. Therefore, with the above configuration, it becomes possible to travel on a narrower road when there is no risk of making the occupant feel uneasy. As a result, it is possible to reduce the time it takes to reach the destination. When the vehicle travels on a narrower road, the transport target as the target may be at least the passenger out of the baggage and the passenger.

It may be preferable that the allowance degree change unit 122e also adds the condition that the subject vehicle can travel on a road to a condition for allowing the driving on roads. A road on which the subject vehicle can travel may be defined as a road on which the difference between the road width and the vehicle width of the subject vehicle is equal to or greater than a threshold value. This makes it possible to prevent a difficulty such as allowing the driving on a road on which the vehicle cannot travel. The threshold mentioned here may be a value that can be arbitrarily set. The allowance degree change unit 122e may acquire and use the vehicle width of the subject vehicle that has been stored in advance in the non-volatile memory of the autonomous driving ECU 10e. The allowance degree change unit 122 e may determine the road width from high-precision map data acquired from the map DB 13.

### Seventh Embodiment

The present disclosure is not limited to the configuration described in the above embodiment, but can also adopt the following configuration as a seventh embodiment. The followings will describe an example of a configuration of the seventh embodiment with reference to the drawings.

<General Configuration of Vehicular System 1f>

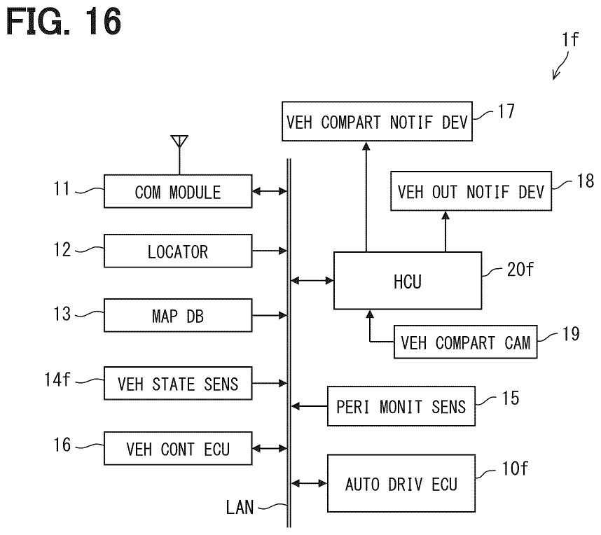

As shown in FIG. 16, the vehicle system 1f includes an autonomous driving ECU 10f, a communication module 11, a locator 12, a map DB 13, a vehicle state sensor 14f, a periphery monitoring sensor 15, a vehicle control ECU 16, a vehicle compartment notification device 17, a vehicle outside notification device 18, a vehicle compartment camera 19, and an HCU 20. The vehicle system 1f includes an autonomous driving ECU 10f instead of the autonomous driving ECU 10. The vehicle system 1f includes a vehicle state sensor 14f instead of the vehicle state sensor 14. The vehicle system 1f includes an HCU 20f instead of the HCU 20. The vehicle system 1f is similar to the vehicle system 1 of the first embodiment except for these points. The service vehicle using the vehicle system 1f may be any of a passenger transport vehicle, a baggage transport vehicle, and a passenger and baggage mixture transport vehicle.

The vehicle state sensor 14f is similar to the vehicle state sensor 14 of the first embodiment, except for some differences. This different point will be described below. It may be preferable to include a sensor (hereinafter, an anomaly related sensor) that detects information relating to an anomaly in the vehicle compartment of the service vehicle. As one example, the anomaly related sensor may include an acoustic sensor that detects sounds within the vehicle compartment.

The HCU 20f is similar to the HCU 20 of the first embodiment, except for some differences. This different point will be described below. The HCU 20f may preferably detect an anomaly in an occupant based on the images captured by the vehicle compartment camera 19. Examples of anomaly in the occupant include poor physical condition. Any anomaly in the occupant may be detected from the occupant's facial expression, posture, and the like.

<General Configuration of Autonomous Driving ECU 10f>

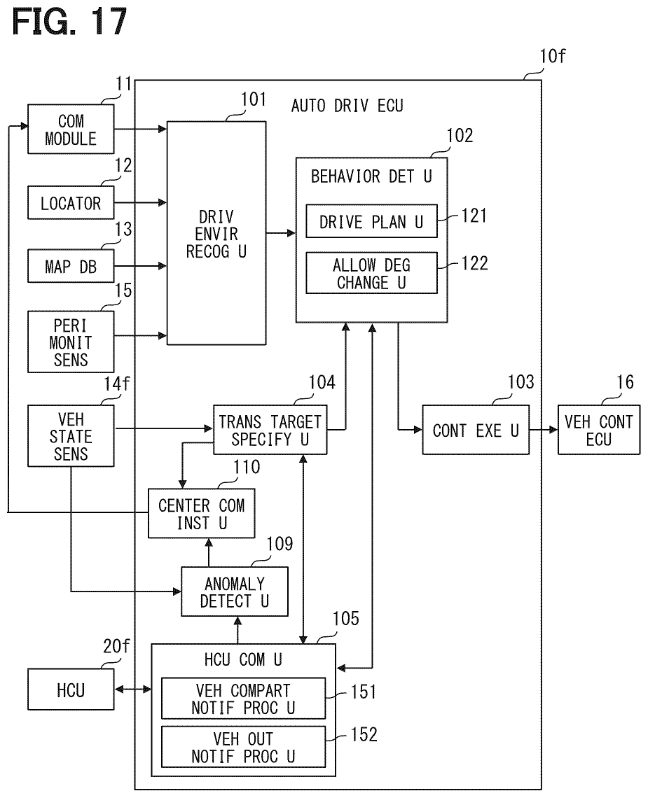

Next, a schematic configuration of the autonomous driving ECU 10f will be described with reference to FIG. 17. The autonomous driving ECU 10f is similar to the autonomous driving ECU 10 of the first embodiment, except for some differences in processing. The autonomous driving ECU 10f has a driving environment recognition unit 101, a behavior determination unit 102, a control execution unit 103, a transport target specifying unit 104, a HCU communication unit 105, an anomaly detection unit 109, and a center communication instruction unit 110 as functional blocks. The autonomous driving ECU 10f is similar to the autonomous driving ECU 10 of the first embodiment, except that the autonomous driving ECU 10f includes an anomaly detection unit 109 and a center communication instruction unit 110. The autonomous driving ECU 10f also corresponds to the vehicle control device. The execution of the processes of the functional blocks of the autonomous driving ECU 10f by the computer corresponds to execution of a vehicle control method.

The anomaly detection unit 109 detects whether or not there is an anomaly in the passenger compartment of the vehicle. The anomaly detection unit 109 may detect the presence or absence of an anomaly from the detection result of the occupant anomaly acquired from the HCU 20f via the HCU communication unit 105. Specifically, if an anomaly in an occupant is detected, it may be determined that an anomaly exists. In the present embodiment, the HCU 20f is configured to detect the anomaly in the occupant, but this is not necessarily limited to the above feature. For example, the anomaly detection unit 109 may detect the anomaly in the passenger from an image captured by the vehicle compartment camera 19 acquired via the HCU communication unit 105. The anomaly detection unit 109 may detect the presence or absence of an anomaly from a detection result of an anomaly related sensor among the vehicle state sensors 14f. For example, when an acoustic sensor detects a sound that is presumed to indicate an anomaly in an occupant or baggage, the sensor may determine that an anomaly exists. Examples of such sounds include the sound of an occupant falling over due to fainting, and the popping sound of baggage.

When the anomaly detection unit 109 detects the presence of an anomaly, the center communication instruction unit 110 notifies a center outside the vehicle that there is an anomaly in the vehicle compartment. A notification that there is an anomaly in the vehicle compartment is hereinafter referred to as an anomaly notification. In this case, the center may be a center that manages the operation of the service vehicles. This center will be referred to as the operation management center hereinafter. The center communication instruction unit 110 may notify the operation management center of the anomaly via the communication module 11. The operation management center that receives the anomaly notification can then execute a procedure for addressing the anomaly in the vehicle compartment.

In addition, even if the anomaly detection unit 109 detects the presence of an anomaly, when the transport target specifying unit 104 specifies that no transport target is disposed in the vehicle, the center communication instruction unit 110 notifies the operation management center of the anomaly as an erroneous detection. Even if the anomaly detection unit 109 detects the presence of an anomaly, when there is no transport target in the subject vehicle, there is a high possibility that the anomaly is an erroneous detection. Therefore, according to the above configuration, when there is a high possibility of an erroneous detection, it is possible to notify the operation management center that the anomaly detection was an erroneous detection. As a result, it is possible to reduce unnecessary processing at the operation management center in response to an erroneous detection.

### Eighth Embodiment

The present disclosure is not limited to the configuration described in the above embodiment, but can also adopt the following configuration as an eight embodiment. The following will describe a detailed example of the eighth embodiment with reference to the accompanying drawings.

<General Configuration of Vehicle System 1g>

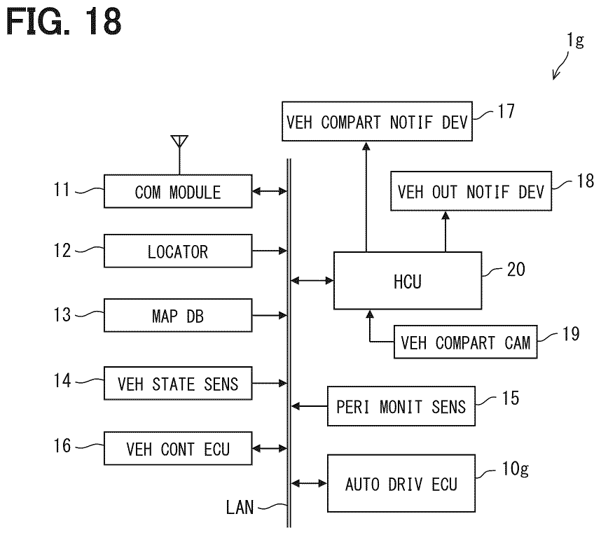

As shown in FIG. 18, the vehicle system 1g includes an autonomous driving ECU 10g, a communication module 11, a locator 12, a map DB 13, a vehicle state sensor 14, a periphery monitoring sensor 15, a vehicle control ECU 16, a vehicle compartment notification device 17, a vehicle outside notification device 18, a vehicle compartment camera 19, and an HCU 20. A vehicle system 1g of the ninth embodiment is similar to the vehicle system 1 of the first embodiment, except that the vehicle system 1g includes an autonomous driving ECU 10g instead of the autonomous driving ECU 10. The service vehicle using the vehicle system 1g may be any of a passenger transport vehicle, a baggage transport vehicle, and a passenger and baggage mixture transport vehicle.

<General Configuration of Autonomous Driving ECU 10g>

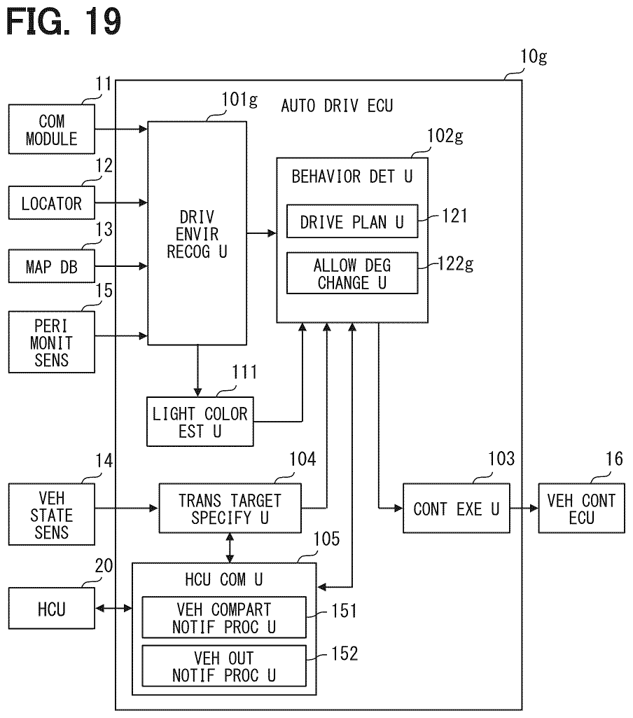

Next, a schematic configuration of the autonomous driving ECU 10g will be described with reference to FIG. 19. The autonomous driving ECU 10g is similar to the autonomous driving ECU 10 of the first embodiment, except for some differences in processing. The autonomous driving ECU 10g has a driving environment recognition unit 101g, a behavior determination unit 102g, a control execution unit 103, a transport target specifying unit 104, an HCU communication unit 105, and a light color estimation unit 111 as functional blocks. The autonomous driving ECU 10g is equipped with a driving environment recognition unit 101g instead of the driving environment recognition unit 101. The autonomous driving ECU 10g includes a behavior determination unit 102g instead of the behavior determination unit 102. The autonomous driving ECU 10g is equipped with a light color estimation unit 111. Except for these points, the autonomous driving ECU 10g is the same as the autonomous driving ECU 10 of the first embodiment. The autonomous driving ECU 10g also corresponds to the vehicle control device. The execution of the processes of the functional blocks of the autonomous driving ECU 10g by the computer corresponds to execution of a vehicle control method.

The driving environment recognition unit 101g is similar to that of the driving environment recognition unit 101 of the first embodiment, except for some differences in processing. This different point will be described below. The driving environment recognition unit 101g may also recognize the light color and blinking state of pedestrian traffic signals from images captured by the periphery monitoring camera using image recognition technique.

The light color estimation unit 111 estimates the light color (hereinafter, target light color) of the vehicle traffic signal at an intersection in the direction in which the subject vehicle will travel when the subject vehicle enters the intersection. For example, when the light color estimation unit 111 can acquire the information on the signal cycle of a vehicle traffic light via road-to-vehicle communication, the light color estimation unit 111 estimates the target light color from the information on the signal cycle. Alternatively, the light color estimation unit 111 may estimate the target light color from the light color and a blinking state of a pedestrian traffic light in the direction in which the subject vehicle is traveling, which is recognized by the driving environment recognition unit 101g. As an example, if the light color of a vehicle traffic light in the direction in which the vehicle is traveling is green but the light color of a pedestrian traffic light is red, the target light color may be estimated to be yellow. Alternatively, when a pedestrian traffic light in the direction in which the vehicle is traveling is flashing green, the target light color may be estimated to be yellow.

The behavior determination unit 102g includes a drive plan unit 121 and an allowance degree change unit 122g as sub-functional blocks. The allowance degree change unit 122g may be similar to the allowance degree change unit 122, except for some differences in the processing. This different point will be described below. The processing in the allowance degree change unit 122g also corresponds to the allowance degree change step.

When the transport target specifying unit 104 specifies that the transport target is disposed in the vehicle, the allowance degree change unit 122g stops the vehicle at an intersection where the light color estimated by the light color estimation unit 111 is yellow. When the transport target specifying unit 104 specifies that the transport target is not disposed in the vehicle, the allowance degree change unit 122g allows the vehicle to pass through an intersection where the light color estimated by the light color estimation unit 111 is yellow. If the transport target is disposed in the service vehicle, it may be preferable to drive carefully and stop the vehicle when entering an intersection where the traffic light is yellow. On the other hand, when the transport target is not disposed in the service vehicle, the need for this careful driving is less necessary. With the above configuration, when the careful driving is less necessary, it is possible to prioritize quick passage through an intersection by passing through an intersection where the light color is estimated to be yellow when entering into the intersection. The allowance degree change unit 122g may accelerate the subject vehicle when passing through an intersection where the light color estimated by the light color estimation unit 111 is yellow.

### Ninth Embodiment

The present disclosure is not limited to the configuration described in the above embodiment, but can also adopt the following configuration as an ninth embodiment. The following will describe a detailed example of the ninth embodiment with reference to the accompanying drawings.

<General Configuration of Vehicle System 1h>

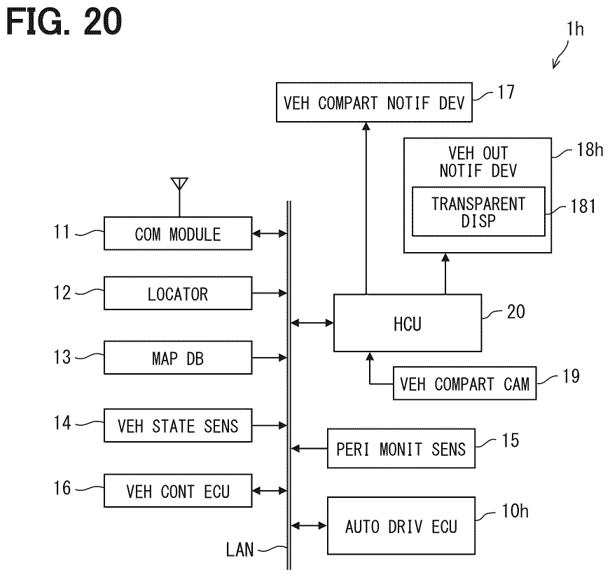

As shown in FIG. 20, the vehicle system 1h includes an autonomous driving ECU 10h, a communication module 11, a locator 12, a map DB 13, a vehicle state sensor 14, a periphery monitoring sensor 15, a vehicle control ECU 16, a vehicle compartment notification device 17, a vehicle outside notification device 18h, a vehicle compartment camera 19, and an HCU 20. The vehicle system 1h includes an autonomous driving ECU 10h instead of the autonomous driving ECU 10. The vehicle system 1h includes the vehicle outside notification device 18h instead of the vehicle outside notification device 18. The vehicle system 1h is similar to the vehicle system 1 of the first embodiment except for these points. The service vehicle using the vehicle system 1h may be any of a passenger transport vehicle, a baggage transport vehicle, and a passenger and baggage mixture transport vehicle.

The vehicle outside notification device 18h is similar to the vehicle outside notification device 18 of the first embodiment, except that some processes are different. The vehicle outside notification device 18h includes at least a transparent display 181. The transparent display 181 may be, for example, a liquid crystal display. The transparent display 181 may be an organic EL display, an inorganic EL display, or the like. The transparent display 181 may be provided on a window of the subject vehicle. The transparent display 181 may be provided on all of windows of the subject vehicle. The transparent display 181 is substantially transparent when no display is being executed, and functions similarly to a window.

<General Configuration of Autonomous Driving ECU 10h>

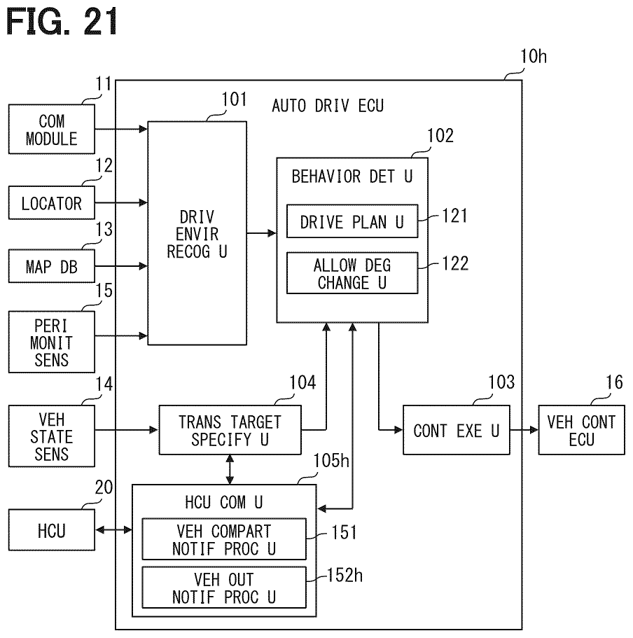

Next, a schematic configuration of the autonomous driving ECU 10h will be described with reference to FIG. 21. The autonomous driving ECU 10h is similar to the autonomous driving ECU 10 of the first embodiment, except for some differences in processing. The autonomous driving ECU 10h has a driving environment recognition unit 101, a behavior determination unit 102, a control execution unit 103, a transport target specifying unit 104, and an HCU communication unit 105h as functional blocks. The autonomous driving ECU 10h is the same as the autonomous driving ECU 10 of the first embodiment, except that the autonomous driving ECU 10h includes an HCU communication unit 105h instead of the HCU communication unit 105. The autonomous driving ECU 10h also corresponds to the vehicle control device. The execution of the processes of the functional blocks of the autonomous driving ECU 10h by the computer corresponds to execution of a vehicle control method.

The HCU communication unit 105h has a vehicle compartment notification processing unit 151 and a vehicle outside notification processing unit 152h as sub-functional blocks. The HCU communication unit 105h is similar to the HCU communication unit 105 of the first embodiment, except that the HCU communication unit 105h has a vehicle outside notification processing unit 152h instead of the vehicle outside notification processing unit 152. The vehicle outside notification processing unit 152h is similar to the vehicle outside notification unit 152 of the first embodiment, except for some differences in processing. This different point will be described below.

When the transport target specifying unit 104 specifies that no transport target is disposed in the vehicle, the vehicle outside notification processing unit 152h controls the transparent display 181 to display an advertisement. In this case, the transport target may be at least the occupant among the baggage and the occupant. When there is no transport target in the vehicle and no occupant is disposed in the vehicle, there is no need for the occupant to view the outside through the window from the vehicle compartment. On the other hand, if an advertisement is displayed on the window when an occupant is disposed in the vehicle, it becomes difficult for the occupant to view the outside through the window. In contrast, with the above configuration, it is possible to display the advertisement on the window only when there is no need to use the window for viewing outside from the vehicle compartment. The window in which advertisement is displayed may be all windows in which the transparent display 181 is provided. This allows for more advertising to be displayed. The transparent display 181 may be provided on all of windows of the subject vehicle. This allows for more advertising to be displayed.

### Tenth Embodiment

In the above-described embodiment, the autonomous driving ECUs 10, 10a, 10b, 10c, 10d, 10e, 10f, 10g, and 10h correspond to a vehicle control device, but this is not necessarily limited to this feature. For example, an ECU other than the autonomous driving ECUs 10, 10a, 10b, 10c, 10d, 10e, 10f, 10g, and 10h may be configured to correspond to the vehicle control device.

### (Technical Features Described Above)

This specification discloses multiple technical ideas described in multiple items listed below. Some features may be described in a multiple dependent form, in which subsequent features alternatively refer to preceding features. Some features may be described in a multiple dependent form referring to another multiple dependent form. These features described in a multiple dependent form define multiple technical features.

### (Technical Feature 1)

A vehicle control device can be used in a service vehicle that transports a transport target as a service using autonomous driving. The vehicle control device includes: at least one of (i) a circuit and (ii) a processor having a memory storing computer program code. The at least one of the circuit and the processor having the memory is configured to cause the vehicle control device to provide: a transport target specifying unit that specifies whether at least one of an occupant and a baggage as the transport target is disposed in the service vehicle; and an allowance degree change unit that changes a driving allowance degree, which is a range of a driving control of the service vehicle allowed in the autonomous driving, according to a specified result by the transport target specifying unit.

### (Technical Feature 2)

In the vehicle control device according to the technical feature 1, the allowance degree change unit widens the driving allowance degree when the transport target specifying unit specifies that no transport target is disposed in the service vehicle, compared to when the transport target specifying unit specifies that the transport target is disposed in the service vehicle.

### (Technical Feature 3)

In the vehicle control device according to the technical feature 1 or 2, the transport target specifying unit specifies the transport target by distinguishing whether at least an occupant as the transport target is disposed in the service vehicle. The transport target specifying unit distinguishes and specifies whether each of a monitoring driver and a passenger as the occupant of the service vehicle is disposed in the service vehicle. The allowance degree change unit narrows the driving allowance degree when the transport target specifying unit specifies that the monitoring driver is disposed and the passenger is not disposed in the service vehicle, compared to when the transport target specifying unit specifies that the monitoring driver is not disposed and the passenger is not disposed in the service vehicle.

### (Technical Feature 4)

In the vehicle control device according to any one of the technical features 1 to 3, the transport target specifying unit specifies the transport target by distinguishing whether at least an occupant as the transport target is disposed in the service vehicle. The transport target specifying unit distinguishes and specifies whether each of a monitoring driver and a passenger as the occupant of the service vehicle is disposed in the service vehicle. The vehicle control device further includes: a vehicle compartment notification processing unit that controls a vehicle compartment notification device for issuing a notification toward a vehicle compartment of the service vehicle. The vehicle compartment notification processing unit controls the vehicle compartment notification device to issue a check prompt notification for prompting the monitoring driver to execute a driving operation and a vehicle check of the service vehicle when the transport target specifying unit specifies that the monitoring driver is disposed in the service vehicle and the passenger is not disposed in the service vehicle.

### (Technical Feature 5)

In the vehicle control device according to any one of the technical features 1 to 4, the transport target specifying unit specifies the transport target by distinguishing whether at least an occupant as the transport target is disposed in the service vehicle. The transport target specifying unit distinguishes and specifies whether each of a monitoring driver and a passenger as the occupant of the service vehicle is disposed in the service vehicle. The allowance degree change unit makes an emergency brake easier to be executed when the transport target specifying unit specifies that the monitoring driver is not disposed and the passenger is not disposed in the service vehicle, compared to when the transport target specifying unit specifies that at least one of the monitoring driver and the passenger is disposed in the service vehicle.

### (Technical Feature 6)

In the vehicle control device according to any one of the technical features 1 to 5, the allowance degree change unit does not allow a lane change for overtaking another vehicle by the service vehicle when the transport target specifying unit specifies that the transport target is disposed in the service vehicle. The allowance degree change unit allows the lane change for overtaking another vehicle by the service vehicle when the transport target specifying unit specifies that the transport target is not disposed in the service vehicle.

### (Technical Feature 7)

In the vehicle control device according to any one of the technical features 1 to 5, the allowance degree change unit increases a numerical number of times for allowing a lane change for overtaking another vehicle by the service vehicle when the transport target specifying unit specifies that the transport target is not disposed in the service vehicle, compared to when the transport target specifying unit specifies that the transport target is disposed in the service vehicle.

### (Technical Feature 8)

The vehicle control device according to any one of the technical features 1 to 7, further includes: a vehicle outside notification processing unit that controls a vehicle outside notification device for issuing a notification toward a vehicle outside of the service vehicle. The vehicle outside notification processing unit controls the vehicle outside notification device to issue the notification indicating that the service vehicle is travelling in the autonomous driving without a transport target when the transport target specifying unit specifies that the transport target is not disposed in the service vehicle.

### (Technical Feature 9)

In the vehicle control device according to any one of the technical features 1 to 8, the allowance degree change unit controls the service vehicle to travel at a lower speed when the transport target specifying unit specifies that the transport target is not disposed in the service vehicle, and the service vehicle transports an occupant as the transport target, compared to when the transport target specifying unit specifies that the transport target is disposed in the service vehicle. The allowance degree change unit controls the service vehicle to travel at a higher speed when the transport target specifying unit specifies that the transport target is not disposed in the service vehicle, and the service vehicle transports a baggage as the transport target, compared to when the transport target specifying unit specifies that the transport target is disposed in the service vehicle.

### (Technical Feature 10)

The vehicle control device according to any one of the technical features 1 to 9, can be used for the service vehicle that transports a baggage as the transport target. The vehicle control device further includes: a baggage information acquisition unit that acquires baggage information relating to a precaution for transporting the baggage to be transported. The allowance degree change unit changes the driving allowance degree in accordance with the baggage information acquired by the baggage information acquisition unit.

### (Technical Feature 11)

In the vehicle control device according to any one of the technical features 1 to 10, the transport target specifying unit distinguishes and specifies whether each of an occupant and a baggage as the transport target is disposed in the service vehicle. The allowance degree change unit changes the driving allowance degree according to a combination of results of specifying by the transport target specifying unit whether each of an occupant and a baggage as the transport target is disposed in the service vehicle.

### (Technical Feature 12)

In the vehicle control device according to the technical feature 11, the transport target specifying unit distinguishes and specifies whether each of an occupant and a baggage as the transport target is disposed in the service vehicle. The allowance degree change unit changes a numerical number of times for allowing a lane change for overtaking another vehicle by the service vehicle, according to a combination of results of specifying by the transport target specifying unit whether each of an occupant and a baggage as the transport target is disposed in the service vehicle.

### (Technical Feature 13)

In the vehicle control device according to any one of the technical features 1 to 12, the allowance degree change unit executes a fuel efficiency improvement control that is a vehicle control for improving a fuel efficiency of the service vehicle when the transport target specifying unit specifies that the transport target is not disposed in the service vehicle, more than when the transport target specifying unit specifies that the transport target is disposed in the service vehicle.

### (Technical Feature 14)

In the vehicle control device according to the technical feature 13, the allowance degree change unit at least turns off an air conditioning device of the service vehicle as the fuel efficiency improvement control. The allowance degree change unit turns on the air conditioning device or opens a window of the service vehicle in a situation where the air conditioning device has been turned off as the fuel efficiency improvement control if it is estimated that a state of the service vehicle will transition to another state where the transport target is disposed in the service vehicle within a predetermined time.

### (Technical Feature 15)

In the vehicle control device according to the technical feature 13 or 14, the allowance degree change unit, as the fuel efficiency improvement control, reduces a change amount of deceleration when stopping the service vehicle in a case where another vehicle behind the service vehicle is not disposed within a specific range, to be lower than a case where another vehicle behind the service vehicle is disposed within the specific range.

### (Technical Feature 16)

In the vehicle control device according to any one of the technical features 13 to 15, the service vehicle is configured to operate a steering wheel in accordance with turning the service vehicle by an autonomous driving operation during the autonomous driving. The allowance degree change unit, as the fuel efficiency improvement control, restricts an operation of the steering wheel in accordance with turning the service vehicle by the autonomous driving operation.

### (Technical Feature 17)

In the vehicle control device according to any one of the technical features 13 to 16, the allowance degree change unit restricts a display on a display device provided in the subject vehicle as the fuel efficiency improvement control.

### (Technical Feature 18)

In the vehicle control device according to the technical feature 17, the service vehicle is equipped with, as the display device, a vehicle compartment display device that displays information toward a vehicle compartment of the service vehicle, and a vehicle outside display device that displays information toward an outside of the service vehicle. The allowance degree change unit, as the fuel efficiency improvement control, restricts only the display on the vehicle compartment display device out of the vehicle compartment display device and the vehicle outside display device.

### (Technical Feature 19)

In the vehicle control device according to any one of the technical features 14 to 18, the allowance degree change unit executes the fuel efficiency improvement control at a timing when a state in which the transport target specifying unit specifies that the transport target is disposed in the service vehicle is transitioned to a state in which the transport target specifying unit specifies that the transport target is not disposed in the service vehicle, and the service vehicle starts travelling in a state in which the transport target specifying unit has specified that the transport target is not disposed in the service vehicle.

### (Technical Feature 20)

In the vehicle control device according to any one of the technical features 1 to 19, when the transport target specifying unit specifies that the transport target is not disposed in the service vehicle, the allowance degree change unit allows the service vehicle to travel on a narrower road than when the transport target specifying unit specifies that the transport target is disposed in the service vehicle.

### (Technical Feature 21)

The vehicle control device according to any one of the technical features 1 to 20, further includes: an anomaly detection unit that detects whether there is an anomaly in a vehicle compartment of the service vehicle; and a center communication instruction unit that notifies a center disposed outside the service vehicle that there is the anomaly in the vehicle compartment of the service vehicle when the anomaly detection unit detects that there is the anomaly. The center communication instruction unit notifies the center of the anomaly as an erroneous detection when the transport target specifying unit specifies that the transport target is not disposed in the service vehicle even if the anomaly detection unit detects that there is the anomaly.

### (Technical Feature 22)

In the vehicle control device according to any one of the technical features 1 to 21, the transport target specifying unit can specify whether the transport target is disposed in the service vehicle, according to a selection input indicating whether the transport target is disposed in the service vehicle, which is received via an user input device that receives an input from an user of the service vehicle.

### (Technical Feature 23)

The vehicle control device according to any one of the technical features 1 to 22, further includes: a light color estimation unit that estimates a light color of a vehicle traffic signal at an intersection in a direction in which the service vehicle will travel when the service vehicle enters the intersection. When the transport target specifying unit specifies that the transport target is disposed in the vehicle, the allowance degree change unit stops the vehicle at the intersection where the light color estimated by the light color estimation unit is yellow. When the transport target specifying unit specifies that the transport target is not disposed in the service vehicle, the allowance degree change unit allows the vehicle to pass through the intersection where the light color estimated by the light color estimation unit is yellow.

### (Technical Feature 24)

In the vehicle control device according to any one of the technical features 1 to 23, the service vehicle is equipped with a transparent display device on a window of the service vehicle as at least a part of a vehicle outside notification device that issues a notification toward an outside of the service vehicle. The vehicle control device further includes: a vehicle outside notification processing unit that controls the vehicle outside notification device. When the transport target specifying unit specifies that the transport target is not disposed in the service vehicle, the vehicle outside notification unit controls the transparent display to display an advertisement.

Note that the present disclosure is not limited to the embodiments described above and can variously be modified within the scope of the present disclosure. An embodiment obtained by appropriately combining the technical features disclosed in different embodiments may also be included in the technical scope of the present disclosure. The control device, control unit and the control method described in the present disclosure may be implemented by a special purpose computer which includes a processor programmed to execute one or more functions executed by computer programs. Alternatively, the processing unit and the method thereof according to the present disclosure may be implemented by a dedicated hardware logic circuit. Alternatively, the device and the method thereof described in the present disclosure may also be implemented by one or more dedicated computers configured as a combination of a processor executing a computer program and one or more hardware logic circuits. The computer program may also be stored on a computer-readable and non-transitory tangible storage medium as an instruction executed by a computer.

It is noted that a flowchart or the processing of the flowchart in the present application includes sections (also referred to as steps), each of which is represented, for instance, as step. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle control device that can be used in a service vehicle that transports a transport target as a service using autonomous driving, the vehicle control device comprising:
a transport target specifying unit that specifies whether at least one of an occupant and a baggage as the transport target is disposed in the service vehicle; and
an allowance degree change unit that changes a driving allowance degree, which is a range of a driving control of the service vehicle allowed in the autonomous driving, according to a specified result by the transport target specifying unit.

2. The vehicle control device according to claim 1, wherein:
the allowance degree change unit widens the driving allowance degree when the transport target specifying unit specifies that the transport target is not disposed in the service vehicle, compared to when the transport target specifying unit specifies that the transport target is disposed in the service vehicle.

3. The vehicle control device according to claim 1, wherein:
the transport target specifying unit specifies the transport target by distinguishing whether at least an occupant as the transport target is disposed in the service vehicle;
the transport target specifying unit specifies the occupant by distinguishing whether each of a monitoring driver and a passenger as the occupant of the service vehicle is disposed in the service vehicle; and
the allowance degree change unit narrows the driving allowance degree when the transport target specifying unit specifies that the monitoring driver is disposed and the passenger is not disposed in the service vehicle, compared to when the transport target specifying unit specifies that the monitoring driver is not disposed and the passenger is not disposed in the service vehicle.

4. The vehicle control device according to claim 1, wherein:
the transport target specifying unit specifies the transport target by distinguishing whether at least an occupant as the transport target is disposed in the service vehicle; and
the transport target specifying unit specifies the occupant by distinguishing whether each of a monitoring driver and a passenger as the occupant of the service vehicle is disposed in the service vehicle,
the vehicle control device further comprising:
a vehicle compartment notification processing unit that controls a vehicle compartment notification device for issuing a notification toward a vehicle compartment of the service vehicle, wherein:
the vehicle compartment notification processing unit controls the vehicle compartment notification device to issue a check prompt notification for prompting the monitoring driver to execute a driving operation and a vehicle check of the service vehicle when the transport target specifying unit specifies that the monitoring driver is disposed in the service vehicle and the passenger is not disposed in the service vehicle.

5. The vehicle control device according to claim 1, wherein:
the transport target specifying unit specifies the transport target by distinguishing whether at least an occupant as the transport target is disposed in the service vehicle; the transport target specifying unit specifies the occupant by distinguishing whether each of a monitoring driver and a passenger as the occupant of the service vehicle is disposed in the service vehicle; and
the allowance degree change unit makes an emergency brake easier to be executed when the transport target specifying unit specifies that the monitoring driver is not disposed and the passenger is not disposed in the service vehicle, compared to when the transport target specifying unit specifies that at least one of the monitoring driver and the passenger is disposed in the service vehicle.

6. The vehicle control device according to claim 1, wherein:
the allowance degree change unit does not allow a lane change for overtaking another vehicle by the service vehicle when the transport target specifying unit specifies that the transport target is disposed in the service vehicle; and
the allowance degree change unit allows the lane change for overtaking another vehicle by the service vehicle when the transport target specifying unit specifies that the transport target is not disposed in the service vehicle.

7. The vehicle control device according to claim 1, wherein:
the allowance degree change unit increases a numerical number of times for allowing a lane change for overtaking another vehicle by the service vehicle when the transport target specifying unit specifies that the transport target is not disposed in the service vehicle, compared to when the transport target specifying unit specifies that the transport target is disposed in the service vehicle.

8. The vehicle control device according to claim 1, further comprising:
a vehicle outside notification processing unit that controls a vehicle outside notification device for issuing a notification toward a vehicle outside of the service vehicle, wherein:
the vehicle outside notification processing unit controls the vehicle outside notification device to issue the notification indicating that the service vehicle is travelling in the autonomous driving without a transport target when the transport target specifying unit specifies that the transport target is not disposed in the service vehicle.

9. The vehicle control device according to claim 1, wherein:
the allowance degree change unit controls the service vehicle to travel at a lower speed when the transport target specifying unit specifies that the transport target is not disposed in the service vehicle, and the service vehicle transports an occupant as the transport target, compared to when the transport target specifying unit specifies that the transport target is disposed in the service vehicle; and
the allowance degree change unit controls the service vehicle to travel at a higher speed when the transport target specifying unit specifies that the transport target is not disposed in the service vehicle, and the service vehicle transports a baggage as the transport target, compared to when the transport target specifying unit specifies that the transport target is disposed in the service vehicle.

10. The vehicle control device according to claim 1 that can be used for the service vehicle that transports a baggage as the transport target, the vehicle control device further comprising:
a baggage information acquisition unit that acquires baggage information relating to a precaution for transporting the baggage to be transported, wherein:
the allowance degree change unit changes the driving allowance degree in accordance with the baggage information acquired by the baggage information acquisition unit.

11. The vehicle control device according to claim 1, wherein:
the transport target specifying unit specifies the transport target by distinguishing whether each of an occupant and a baggage as the transport target is disposed in the service vehicle; and
the allowance degree change unit changes the driving allowance degree according to a combination of results of specifying by the transport target specifying unit whether each of an occupant and a baggage as the transport target is disposed in the service vehicle.

12. The vehicle control device according to claim 11, wherein:
the transport target specifying unit specifies the transport target by distinguishing whether each of an occupant and a baggage as the transport target is disposed in the service vehicle; and
the allowance degree change unit changes a numerical number of times for allowing a lane change for overtaking another vehicle by the service vehicle, according to a combination of results of specifying by the transport target specifying unit whether each of an occupant and a baggage as the transport target is disposed in the service vehicle.

13. The vehicle control device according to claim 1, wherein:
the allowance degree change unit executes a fuel efficiency improvement control that is a vehicle control for improving a fuel efficiency of the service vehicle when the transport target specifying unit specifies that the transport target is not disposed in the service vehicle, more than when the transport target specifying unit specifies that the transport target is disposed in the service vehicle.

14. The vehicle control device according to claim 13, wherein:
the allowance degree change unit at least turns off an air conditioning device of the service vehicle as the fuel efficiency improvement control; and
the allowance degree change unit turns on the air conditioning device or opens a window of the service vehicle in a situation where the air conditioning device has been turned off as the fuel efficiency improvement control if it is estimated that a state of the service vehicle will transition to another state where the transport target is disposed in the service vehicle within a predetermined time.

15. The vehicle control device according to claim 13, wherein:
the allowance degree change unit, as the fuel efficiency improvement control, reduces a change amount of deceleration when stopping the service vehicle in a case where another vehicle behind the service vehicle is not disposed within a specific range, to be lower than a case where another vehicle behind the service vehicle is disposed within the specific range.

16. The vehicle control device according to claim 13, wherein:
the service vehicle is configured to operate a steering wheel in accordance with turning the service vehicle by the autonomous driving during the autonomous driving; and
the allowance degree change unit, as the fuel efficiency improvement control, restricts an operation of the steering wheel in accordance with turning the service vehicle by the autonomous driving.

17. The vehicle control device according to claim 13, wherein:
the allowance degree change unit restricts a display on a display device provided in the service vehicle as the fuel efficiency improvement control.

18. The vehicle control device according to claim 17, wherein:
the service vehicle is equipped with, as the display device, a vehicle compartment display device that displays information toward a vehicle compartment of the service vehicle, and a vehicle outside display device that displays information toward an outside of the service vehicle; and
the allowance degree change unit, as the fuel efficiency improvement control, restricts only the display on the vehicle compartment display device out of the vehicle compartment display device and the vehicle outside display device.

19. The vehicle control device according to claim 14, wherein:
the allowance degree change unit executes the fuel efficiency improvement control at a timing when a state in which the transport target specifying unit specifies that the transport target is disposed in the service vehicle is transitioned to a state in which the transport target specifying unit specifies that the transport target is not disposed in the service vehicle, and the service vehicle starts travelling in a state in which the transport target specifying unit has specified that the transport target is not disposed in the service vehicle.

20. The vehicle control device according to claim 1, wherein:
when the transport target specifying unit specifies that the transport target is not disposed in the service vehicle, the allowance degree change unit allows the service vehicle to travel on a narrower road than when the transport target specifying unit specifies that the transport target is disposed in the service vehicle.

21. The vehicle control device according to claim 1, further comprising:
an anomaly detection unit that detects whether there is an anomaly in a vehicle compartment of the service vehicle; and
a center communication instruction unit that notifies a center disposed outside the service vehicle that there is the anomaly in the vehicle compartment of the service vehicle when the anomaly detection unit detects that there is the anomaly, wherein:
the center communication instruction unit notifies the center of the anomaly as an erroneous detection when the transport target specifying unit specifies that the transport target is not disposed in the service vehicle even if the anomaly detection unit detects that there is the anomaly.

22. The vehicle control device according to claim 1, wherein:
the transport target specifying unit can specify whether the transport target is disposed in the service vehicle, according to a selection input indicating whether the transport target is disposed in the service vehicle, which is received via an user input device that receives an input from an user of the service vehicle.

23. The vehicle control device according to claim 1, further comprising:
a light color estimation unit that estimates a light color of a vehicle traffic signal at an intersection in a direction in which the service vehicle will travel when the service vehicle enters the intersection, wherein:
when the transport target specifying unit specifies that the transport target is disposed in the vehicle, the allowance degree change unit stops the service vehicle at the intersection where the light color estimated by the light color estimation unit is yellow; and
when the transport target specifying unit specifies that the transport target is not disposed in the service vehicle, the allowance degree change unit allows the vehicle to pass through the intersection where the light color estimated by the light color estimation unit is yellow.

24. The vehicle control device according to claim 1, wherein:
the service vehicle is equipped with a transparent display device on a window of the service vehicle as at least a part of a vehicle outside notification unit that issues a notification toward an outside of the service vehicle,
the vehicle control device further comprising:
a vehicle outside notification processing unit that controls the vehicle outside notification unit, wherein:
when the transport target specifying unit specifies that the transport target is not disposed in the service vehicle, the vehicle outside notification unit controls the transparent display to display an advertisement.

25. The vehicle control device according to claim 1, further comprising:
at least one of (i) a circuit and (ii) a processor having a memory storing computer program code, wherein:
the at least one of the circuit and the processor having the memory is configured to cause the vehicle control device to provide at least one of: the transport target specifying unit; and the allowance degree change unit.

26. A vehicle control method that can be used in a service vehicle that transports a transport target as a service using autonomous driving, the vehicle control method, executed by at least one processor, comprising:
a transport target specifying step for specifying whether at least one of an occupant and a baggage is disposed as a transport target in the service vehicle; and
an allowance degree change step for changing a driving allowance degree, which is a range of a driving control of the service vehicle allowed in the autonomous driving, according to a specified result in the transport target specifying step.
